(19) United States
(12) Patent Application Publication
(10) Pub. No.: US 2016/0275602 A1
(43) Pub. Date: Sep. 22, 2016

(54) COMPUTER-IMPLEMENTED TRADING PLATFORM

(71) Applicant: R.T.J. RAPAPORT TECHNOLOGIES JERUSALEM LTD., Jerusalem (IL)

(72) Inventor: Martin RAPAPORT, New York, NY (US)

(21) Appl. No.: 15/047,082

(22) Filed: Feb. 18, 2016

Related U.S. Application Data
(60) Provisional application No. 62/135,387, filed on Mar. 19, 2015.

(51) Int. Cl. G06Q 30/08

(52) U.S. Cl. CPC G06Q 30/08

(57) ABSTRACT

A computer-implemented trading platform including computerized listing functionality providing to users a listing of asking prices and bid prices for a multiplicity of items, computerized deal making functionality enabling a buying user to make a deal with a selling user by making a bid which matches an asking price and enabling a selling user to make a deal with a buying user by accepting a bid, wherein identities of the buying user and the selling user are not known to each other and computerized deal implementing functionality operative following the making of a deal, for transferring payment relating to the deal as per the bid and the asking price from the buying user to the selling user via an account administered by the computerized deal implementing functionality and transferring the item, which item is the subject of the deal from the selling user to the buying user via a physical facility controlled by the computerized deal implementing functionality.

### REFERENCE TO RELATED PATENTS AND PATENT APPLICATIONS

Reference is hereby made to U.S. Provisional Patent Application 62/135,387, entitled COMPUTER-IMPLEMENTED TRADING PLATFORM, filed Mar. 19, 2015, the disclosure of which is hereby incorporated by reference and priority of which is hereby claimed pursuant to 37 CFR 1.78(a)(4) and (5)(i).

Reference is also made to the following patent and patent applications which are related to the present application, the disclosures of which are hereby incorporated by reference:

U.S. Pat. No. 5,950,178; and

U.S. Patent Publication No. 2014/0279337.

### FIELD OF THE INVENTION

The present invention relates to computerized trading systems and methodologies, and more particularly to computerized trading systems for diamonds and other precious stones.

### BACKGROUND OF THE INVENTION

There exist various technologies for trading in various goods, including providing clearinghouse services.

### SUMMARY OF THE INVENTION

The present invention seeks to provide a computerized trading system and methodology useful to buyers and sellers of goods, particularly precious stones.

There is thus provided in accordance with a preferred embodiment of the present invention a computer-implemented trading platform including computerized listing functionality providing to users a listing of asking prices and bid prices for a multiplicity of items, computerized deal making functionality enabling a buying user to make a deal with a selling user by making a bid which matches an asking price and enabling a selling user to make a deal with a buying user by accepting a bid, wherein identities of the buying user and the selling user are not known to each other and computerized deal implementing functionality operative following the making of a deal, for transferring payment relating to the deal as per the bid and the asking price from the buying user to the selling user via an account administered by the computerized deal implementing functionality and transferring the item, which item is the subject of the deal from the selling user to the buying user via a physical facility controlled by the computerized deal implementing functionality.

In accordance with a preferred embodiment of the present invention, the computer-implemented trading platform also includes deal guaranteeing functionality providing a guarantee of transfer of the payment and delivery of the item to the selling user and the buying user respectively.

In accordance with another preferred embodiment of the present invention, the computer-implemented trading platform also includes item quality certification functionality, providing a certification of at least one quality parameter of a plurality of the multiplicity of items.

In accordance with a further preferred embodiment of the present invention, the computerized listing functionality provides to users a listing of asking prices and bid prices for a multiplicity of items at given delivery locations, the computerized deal making functionality enables a buying user to make a deal with a selling user by making a bid which matches an asking price for a delivery location specified by the selling user and enables a selling user to make a deal with a buying user by accepting a bid for a delivery location specified by the buying user, wherein identities of the buying user and the selling user are not known to each other and the computerized deal implementing functionality is operative following the making of a deal to transfer payment relating to the deal as per the bid and the asking price from the buying user to the selling user via an account administered by the computerized deal implementing functionality and to transfer the item which is the subject of the deal from the selling user to the buying user at a delivery location agreed by the selling user and the buying user in the deal, via the physical facility controlled by the computerized deal implementing functionality.

Preferably, the items are selected from precious stones and diamonds.

Preferably, the computerized listing functionality causes at least one screen to be displayed including at least a menu bar including at least the following selectable top level menu items: BID/ASK LISTINGS, BID/ASK SCREEN and TRANSACTIONS.

Preferably, a default initial screen indicates a selection of BID/ASK LISTINGS.

Preferably, the at least one screen includes a second-level menu for each of the selectable top level menu items, the second-level menu including at least one of the following second-level menu items for the top level menu item BID/ASK LISTINGS: ALL DIAMOND LISTINGS, MY DIAMONDS FOR SALE, MY DIAMONDS WITH BIDS, MY BIDS, ALL DIAMOND BIDS, TRACKED DIAMONDS, ADD DIAMONDS.

Preferably, the at least one screen includes a searchable array which appears when the top level menu item BID/ASK LISTINGS is selected and irrespective of which of the second-level menu items is selected, the searchable array including at least one sub-array enabling searching by at least three of diamond shape, size, color, clarity, cut, polish, symmetry and fluorescence.

Preferably, the searchable array also includes at least one subarray enabling searching by at least one of delivery location and certification laboratory.

Preferably, the searchable array also includes at least one subarray enabling searching by at least one of price/carat, % percentage price difference between at least one of an asking price and a bid price and a benchmark price, total price and lot number.

Preferably, the searchable array also includes an advanced search array including at least one subarray, which enables searching by at least one of Table %, Depth %, Girdle, Culet, Brand and Shade. Preferably, the searchable array also includes an advanced search array including at least one subarray which enables searching by at least one of length, depth, width, ratio and numbers of at least one of black, central and milky inclusions.

Preferably, the computerized listing functionality also provides a list of all diamonds listed on the platform, the list being filterable by a user.

In accordance with a preferred embodiment of the present invention, the computerized deal making functionality includes functionality enabling the buying user to request exclusivity with respect to a given item.

Preferably, the computerized deal making functionality includes functionality enabling at least one of the buying user and the selling user to interact via the platform in a manner other than accepting or declining to accept a given bid.

Preferably, the computerized deal making functionality includes functionality enabling the buying user to request privacy with respect to a given item.

In accordance with another preferred embodiment of the present invention, the computerized listing functionality includes functionality enabling display to a user of comments inserted by an operator of the platform regarding a specific item.

Preferably, the computerized deal making functionality includes functionality enabling a selling user to set bidding limitations with respect to a given item. Preferably, the computerized deal making functionality includes functionality enabling a buying user to at least set and change a conditional asking price.

There is further provided, in accordance with another preferred embodiment of the present invention, a computer-implemented method for trading including providing to users, using computerized listing functionality, a listing of asking prices and bid prices for a multiplicity of items, enabling a buying user, utilizing computerized deal making functionality, to make a deal with a selling user by making a bid which matches an asking price, enabling a selling user, utilizing the computerized deal making functionality, to make a deal with a buying user by accepting a bid, wherein identities of the buying user and the selling user are not known to each other, transferring payment relating to the deal, utilizing computerized deal implementing functionality, following the making of the deal, as per the bid and the asking price from the buying user to the selling user via an account administered by the computerized deal implementing functionality, and transferring the item, which is the subject of the deal from the selling user to the buying user via a physical facility controlled by the computerized deal implementing functionality.

In accordance with a preferred embodiment of the computer-implemented method for trading of the present invention, the method also includes providing a guarantee, utilizing computerized deal guaranteeing functionality, of transfer of the payment and delivery of the item to the selling user and the buying user respectively.

In accordance with another preferred embodiment of the computer-implemented method for trading of the present invention, the method also includes providing a certification, utilizing item quality certification functionality, of at least one quality parameter of a plurality of the multiplicity of items.

In accordance with yet another preferred embodiment of the computer-implemented method for trading of the present invention, the computerized listing functionality provides to users a listing of asking prices and bid prices for a multiplicity of items at given delivery locations, the computerized deal making functionality enables a buying user to make a deal with a selling user by making a bid which matches an asking price for a delivery location specified by the selling user and enables a selling user to make a deal with a buying user by accepting a bid for a delivery location specified by the buying user, wherein identities of the buying user and the selling user are not known to each other and the computerized deal implementing functionality is operative following the making of the deal for transferring payment relating to the deal as per the bid and the asking price from the buying user to the selling user via an account administered by the computerized deal implementing functionality and transferring the item which is the subject of the deal from the selling user to the buying user at the delivery location agreed by the selling user and the buying user in the deal, via the physical facility controlled by the computerized deal implementing functionality.

Preferably, the items are selected from precious stones and diamonds.

Preferably, the computerized listing functionality of the method of the present invention causes at least one screen to be displayed including at least a menu bar including at least the following selectable top level menu items: BID/ASK LISTINGS, BID/ASK SCREEN and TRANSACTIONS.

Preferably, at least a default initial screen indicates a selection of BID/ASK LISTINGS.

Preferably, the at least one screen includes a second-level menu for each of the selectable top level menu items, the second-level menu including at least one of the following second-level menu items for the top menu item BID/ASK LISTINGS: ALL DIAMOND LISTINGS, MY DIAMONDS FOR SALE, MY DIAMONDS WITH BIDS, MY BIDS, ALL DIAMOND BIDS, TRACKED DIAMONDS, ADD DIAMONDS.

Preferably, the at least one screen includes a searchable array which appears when the top level menu item BID/ASK LISTINGS is selected and irrespective of which of the second-level menu items is selected, the searchable array including at least one sub-array enabling searching by at least three of diamond shape, size, color, clarity, cut, polish, symmetry and fluorescence.

Preferably, the searchable array also includes at least one subarray enabling searching by at least one of delivery location and certification laboratory. Preferably, the searchable array also includes at least one subarray enabling searching by at least one of price/carat, % percentage price difference between at least one of an asking price and a bid price and a benchmark price, total price and lot number.

Preferably, the searchable array also includes an advanced search array including at least one subarray, which enables searching by at least one of Table %, Depth %, Girdle, Culet, Brand and Shade. Preferably, the searchable array also includes an advanced search array including at least one subarray which enables searching by at least one of length, depth, width, ratio and numbers of at least one of black, central and milky inclusions.

Preferably, the computerized listing functionality of the method of the present invention also provides a list of all diamonds listed on a platform, the list being filterable by a user.

Preferably, the computerized deal making functionality of the method of the present invention includes functionality enabling a buying user to request exclusivity with respect to a given item.

Preferably, the computerized deal making functionality of the method of the present invention includes functionality enabling at least one of a buying user and a selling user to interact in a manner other than accepting or declining to accept a given bid.

Preferably, the computerized deal making functionality of the method of the present invention includes functionality enabling a buying user to request privacy with respect to a given item.

Preferably, the computerized listing functionality of the method of the present invention includes functionality enabling display to a user of comments inserted by an operator regarding a specific item.

Preferably, the computerized deal making functionality of the method of the present invention includes functionality enabling a selling user to set bidding limitations with respect to a given item.

Preferably, the computerized deal making functionality of the method of the present invention includes functionality enabling a buying user to at least set and change a conditional asking price.

There is additionally provided, in accordance with still another preferred embodiment of the present invention, a non-transitory computer readable medium having stored thereupon computer instructions including code segments having the following functionalities: computerized listing functionality providing to users a listing of asking prices and bid prices for a multiplicity of items, computerized deal making functionality enabling a buying user to make a deal with a selling user by making a bid which matches an asking price and enabling a selling user to make a deal with a buying user by accepting a bid, wherein identities of the buying user and the selling user are not known to each other and computerized deal implementing functionality operative following the making of a deal for transferring payment relating to the deal as per the bid and the asking price from the buying user to the selling user via an account administered by the computerized deal implementing functionality and transferring the item, which is the subject of the deal from the selling user to the buying user via a physical facility controlled by the computerized deal implementing functionality.

In accordance with a preferred embodiment of the non-transitory computer readable medium of the present invention, the instructions also include code segments having deal guaranteeing functionality providing a guarantee of transfer of the payment and delivery of the item to the selling user and the buying user respectively.

In accordance with another preferred embodiment of the non-transitory computer readable medium of the present invention, the instructions also include code segments having item quality certification functionality, providing a certification of at least one quality parameter of a plurality of the multiplicity of items.

In accordance with a further preferred embodiment of the non-transitory computer readable medium of the present invention, the computerized listing functionality provides to users a listing of asking prices and bid prices for a multiplicity of items at given delivery locations, the computerized deal making functionality enables a buying user to make a deal with a selling user by making a bid which matches an asking price for a delivery location specified by the selling user and enables a selling user to make a deal with a buying user by accepting a bid for a delivery location specified by the buying user, wherein identities of the buying user and the selling user are not known to each other and the computerized deal implementing functionality is operative following the making of the deal for transferring payment relating to the deal as per the bid and the asking price from the buying user to the selling user via an account administered by the computerized deal implementing functionality and transferring the item which is the subject of the deal from the selling user to the buying user at a delivery location agreed by the selling user and the buying user in the deal, via the physical facility controlled by the computerized deal implementing functionality.

Preferably, the items are selected from precious stones and diamonds.

Preferably, the computerized listing functionality of the non-transitory computer readable medium of the present invention causes at least one screen to be displayed including at least a menu bar including at least the following selectable top level menu items: BID/ASK LISTINGS, BID/ASK SCREEN and TRANSACTIONS.

Preferably, at least a default initial screen indicates a selection of BID/ASK LISTINGS.

Preferably, the at least one screen includes a second-level menu for each of the selectable top level menu items, the second-level menu including at least one of the following second-level menu items for the top menu item BID/ASK LISTINGS: ALL DIAMOND LISTINGS, MY DIAMONDS FOR SALE, MY DIAMONDS WITH BIDS, MY BIDS, ALL DIAMOND BIDS, TRACKED DIAMONDS, ADD DIAMONDS.

Preferably, the at least one screen includes a searchable array which appears when the top level menu item BID/ASK LISTINGS is selected and irrespective of which of the second-level menu items is selected, the searchable array including at least one sub-array enabling searching by at least three of diamond shape, size, color, clarity, cut, polish, symmetry and fluorescence.

Preferably, the searchable array also includes at least one subarray enabling searching by at least one of delivery location and certification laboratory. Preferably, the searchable array also includes at least one subarray enabling searching by at least one of price/carat, % percentage price difference between at least one of an asking price and a bid price and a benchmark price, total price and lot number. Preferably, the searchable array also includes an advanced search array including at least one subarray, which enables searching by at least one of Table %, Depth %, Girdle, Culet, Brand and Shade.

Preferably, the searchable array also includes an advanced search array including at least one subarray which enables searching by at least one of length, depth, width, ratio and numbers of at least one of black, central and milky inclusions.

Preferably, the computerized listing functionality of the non-transitory computer readable medium of the present invention also provides a list of all diamonds listed on a platform, the list being filterable by a user.

Preferably, the computerized deal making functionality of the non-transitory computer readable medium of the present invention includes functionality enabling a buying user to request exclusivity with respect to a given item.

Preferably, the computerized deal making functionality of the non-transitory computer readable medium of the present invention includes functionality enabling at least one of a buying user and a selling user to interact in a manner other than accepting or declining to accept a given bid. Preferably, the computerized deal making functionality of the non-transitory computer readable medium of the present invention includes functionality enabling a buying user to request privacy with respect to a given item.

Preferably, the computerized listing functionality of the non-transitory computer readable medium of the present invention includes functionality enabling display to a user of comments inserted by an operator regarding a specific item.

Preferably, the computerized deal making functionality of the non-transitory computer readable medium of the present invention includes functionality enabling a selling user to set bidding limitations with respect to a given item.

Preferably, the computerized deal making functionality of the non-transitory computer readable medium of the present invention also includes functionality enabling a buying user to at least set and change a conditional asking price.

### BRIEF DESCRIPTION OF THE DRAWINGS

The present invention will be understood and appreciated more fully from the following detailed description, taken in conjunction with the drawings in which:

FIG. 1 is a simplified illustration of an initial screen indicating a default top level menu selection, displayed to a user of a computer-implemented trading platform constructed and operative in accordance with a preferred embodiment of the present invention;

FIG. 2 is a simplified illustration of another screen displayed to a user as a result of a selection made by the user in an initial screen of the type shown in FIG. 1;

FIGS. 3A-3G are simplified respective illustrations of further screens respectively displayed to a user as a result of respective selections made by the user in a screen of the type shown in FIG. 2;

FIG. 4 is a simplified illustration of yet another screen displayed to a buying user as a result of a selection made by the buying user in a screen of the type shown in FIG. 2;

FIGS. 5A-5F are simplified respective illustrations of still other screens respectively displayed to a selling user as a result of a selection made by the selling user in a screen of the type shown in FIG. 2;

FIG. 6 is a simplified illustration of an initial screen of the type illustrated in FIG. 1 but indicating an alternative top level menu selection;

FIG. 7 is a simplified illustration of another screen displayed to a user as a result of a selection made by the user in an initial screen of the type shown in FIG. 6;

FIG. 8 is a simplified illustration of still another screen displayed to a user as a result of a selection made by the user in a screen of the type shown in FIG. 7;

FIG. 9 is a simplified illustration of yet another screen displayed to a user as a result of an alternative selection made by the user in a screen of the type shown in FIG. 7;

FIG. 10 is a simplified illustration of another initial screen of the type illustrated in FIGS. 1 and 6, but indicating a further alternative top level menu selection and a default corresponding sub-menu selection;

FIG. 11 is a simplified illustration of a further screen displayed to a user as a result of a selection made by the user in a screen of the type shown in FIG. 10;

FIGS. 12A and 12B are simplified respective illustrations of yet further screens displayed to a buying user and a selling user respectively, following a selection made by the buying and selling users in a screen of the type shown in FIG. 11;

FIG. 13 is a simplified illustration of an initial screen of the type illustrated in FIG. 10, but indicating an alternative sub-menu selection;

FIG. 14 is a simplified illustration of another screen displayed to a user as a result of a selection made by the user in a screen of the type shown in FIG. 13;

FIGS. 15A and 15B are simplified respective illustrations of still further screens displayed to a selling user and a buying user respectively following a selection made by the selling and buying user in a screen of the type shown in FIG. 14;

FIG. 16 is a simplified illustration of an initial screen of the type illustrated in FIGS. 10 and 13, but indicating another alternative sub-menu selection;

FIG. 17 is a simplified illustration of an initial screen indicating a default top level menu selection, displayed to an administrator of a computer-implemented trading platform constructed and operative in accordance with a preferred embodiment of the present invention;

FIG. 18 is a simplified illustration of a further screen displayed to an administrator as a result of a selection made by the administrator in a screen of the type shown in FIG. 17;

FIG. 19 is a simplified illustration of a still further screen displayed to an administrator as a result of a selection made by the administrator in a screen of the type shown in FIG. 18;

FIGS. 20A-20K are simplified respective illustrations of yet further screens displayed to an administrator as a result of selections made by the administrator in a screen of the type shown in FIG. 19;

FIG. 21 is a simplified illustration of an initial screen of the type shown in FIG. 17, but indicating an alternative top level menu selection;

FIG. 22 is a simplified illustration of another screen displayed to an administrator as a result of a selection made by the administrator in a screen of the type shown in FIG. 21;

FIG. 23 is a simplified illustration of still another screen displayed to an administrator as a result of a selection made by the administrator in a screen of the type shown in FIG. 22;

FIG. 24 is a simplified illustration of yet another screen displayed to an administrator as a result of an alternative selection made by the administrator in a screen of the type shown in FIG. 22;

FIG. 25 is a simplified illustration of a further initial screen of the type shown in FIGS. 17 and 21, but indicating an alternative top level menu selection;

FIG. 26 is a simplified illustration of a still further screen displayed to an administrator as a result of a selection made by the administrator in a screen of the type shown in FIG. 25; and

FIG. 27 is a simplified illustration of yet a further screen displayed to an administrator as a result of a selection made by the administrator in a screen of the type shown in FIG. 26.

### DETAILED DESCRIPTION OF PREFERRED EMBODIMENTS

The present invention provides a computerized trading system and computer-implemented method for trading which are useful to buyers and sellers of goods. The computerized trading system and method for trading of the present invention may be implemented by a non-transitory computer readable medium having stored thereupon computer instructions including code segments which are functional to execute aspects of the system and method of the present invention. In the example described hereinbelow, the goods for trading are diamonds, it being understood and appreciated that the system and method may be applicable to other types of goods as well with suitable modifications.

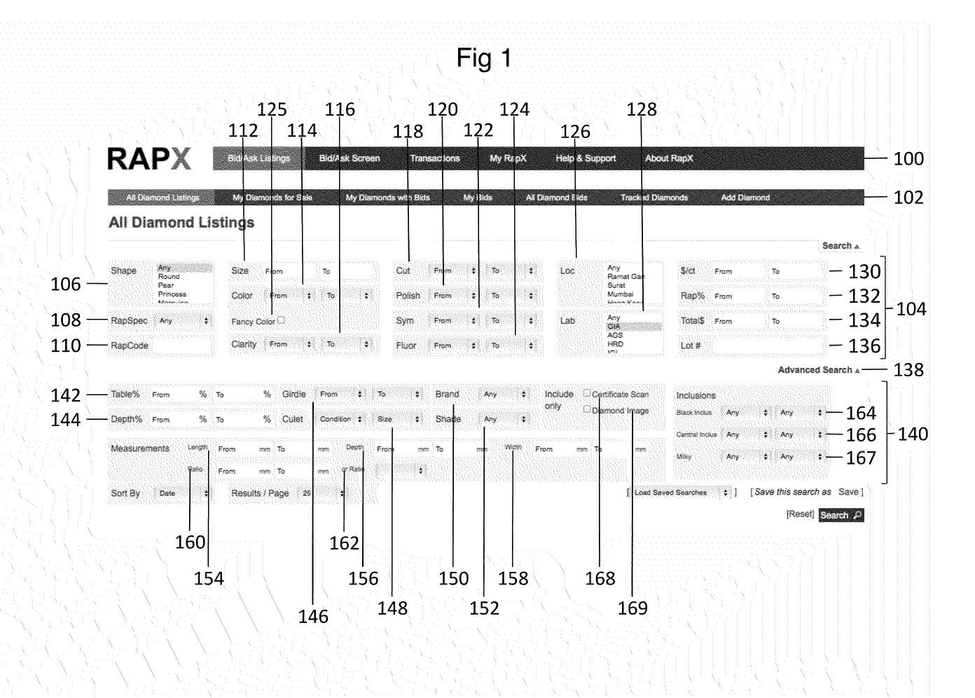

Reference is now made to FIG. 1, which illustrates an initial screen shown to a user, who may be a potential seller or buyer. The initial screen includes a top menu bar 100 which includes a top-level menu including at least the following menu items: BID/ASK LISTINGS, BID/ASK SCREEN, TRANSACTIONS, MY RAPX, HELP&SUPPORT, ABOUT RAPX. Preferably, the default initial screen indicates a selection of BID/ASK LISTINGS.

Preferably, below top menu bar 100 is a secondary menu bar 102, which includes a second-level menu for each of the selectable top level menu items. In this case, the secondary menu bar 102 shows the following second-level menu items for the top menu item BID/ASK LISTINGS: ALL DIAMOND LISTINGS, MY DIAMONDS FOR SALE, MY DIAMONDS WITH BIDS, MY BIDS, ALL DIAMOND BIDS, TRACKED DIAMONDS, ADD DIAMONDS. Preferably, the default initial screen indicates a selection of ALL DIAMOND LISTINGS.

Preferably below secondary menu bar 102 is a searchable array 104 which appears if the top level menu item BID/ASK LISTINGS is selected and irrespective of which of the second-level menu items is selected. The searchable array 104 enables the user to search the system, as per the second-level menu item in secondary menu bar 102 that is selected.

The searchable array 104 includes a sub-array 106 enabling searching by diamond shape, a sub-array 108 enabling searching by RapSpec and a sub-array 110 enabling searching by RapCode. RapSpec and RapCode are parameters which are known in the art, as defined at www.diamonds.net and implemented in the prior art Rapaport Diamond Trading Network, commonly known as RapNet. The searchable array 104 also includes subarrays 112, 114 and 116, which enable searching by size, color and clarity, respectively, and subarrays 118, 120, 122 and 124, which enable searching by cut, polish, symmetry and fluorescence, respectively. The searchable array 104 also preferably includes a clickable Fancy Color check box 125.

The searchable array 104 also includes subarrays 126 and 128, which enable searching by delivery location and certification laboratory. The searchable array 104 also preferably includes subarrays 130, 132, 134 and 136, which enable searching by price/carat, % percentage price difference, such as difference from the price set forth in the Rapaport Diamond Report pricelist, total price and lot #, respectively.

Below searchable array 104 is an icon 138 allowing a user to access an advance search functionality. Clicking on icon 138 causes an advanced search array 140 to appear below searchable array 104. The advanced search array 140 preferably includes subarrays 142, 144, 146, 148, 150 and 152, which enable searching by Table %, Depth %, Girdle, Culet, Brand and Shade, respectively. The advanced search array 140 preferably also includes subarrays 154, 156, 158, 160 and 162, which enable searching by length, depth, width and ratio respectively. The advanced search array 140 preferably also includes subarrays 164, 166 and 167, which enable searching by numbers of black, central and milky inclusions. The advanced searchable array 140 also preferably includes two clickable check boxes 168 and 169, for enabling selection of certificate scan and diamond image, respectively. Typically, below advanced search array 140 there appears a default list (not shown) of all diamonds in the system. This list can be filtered by the user employing searchable array 104 and advanced search array 140.

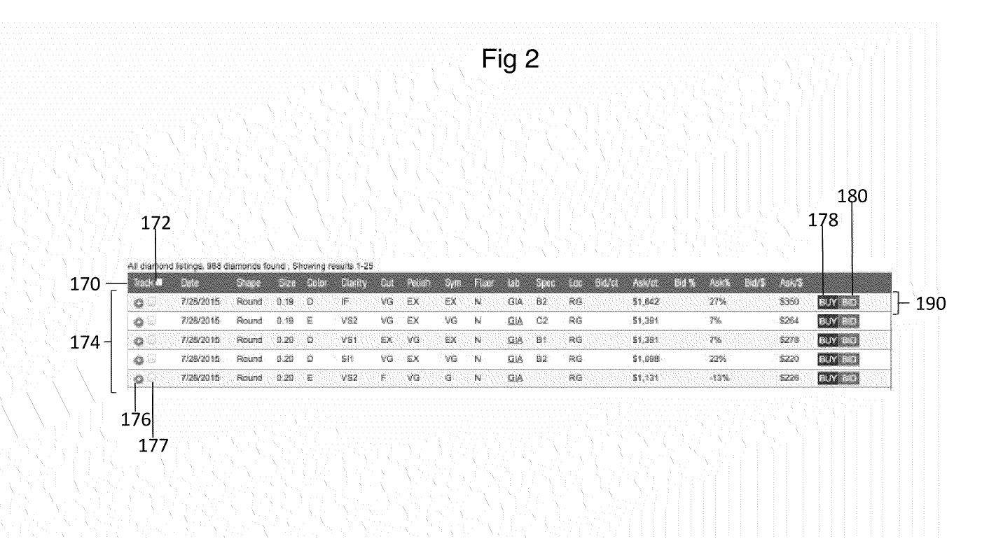

Reference is now made to FIG. 2, which illustrates a search results screen produced by the system as the result of searching using either of searchable arrays 104 and 140. A top line 170 of the search results screen of FIG. 2 includes a Track icon 172 which enables a user to track all of the diamonds appearing on the search results screen and also lists various parameters which appear in the listings there below. Preferably these parameters include Date, Shape, Size, Color, Clarity, Cut, Polish, Symmetry, Fluorescence, Certification Laboratory, Rap Spec, Delivery Location, Bid/Ct amount, Ask/Ct amount, Bid % of a benchmark price, such as the price set forth in Rapaport Diamond Report pricelist, Ask % of the price such as the price set forth in Rapaport Diamond Report pricelist, total Bid price per diamond, and total Ask price per diamond.

Below the top line 170 is a sequential list 174 of diamonds, one line per diamond, in which all relevant ones of the above parameters appear. Additionally, typically at the left side of each line there appears a clickable plus icon 176 and a clickable track check box 177. Typically at the right side of each line there appears a clickable BUY icon 178 and a clickable BID icon 180.

It is appreciated that the initial screen and search results screen shown in FIGS. 1 and 2 respectively represent computerized listing functionality, providing to users a listing of asking prices and bid prices for a multiplicity of items, the items being here embodied, by way of example, as diamonds.

There may be multiple scenarios at this stage which reflect the relationship between the user and a given listed diamond. The user may be, for example, a person who has neither listed nor previously bid on the diamond (Scenario A), the person who previously bid on a diamond listed by another person (Scenario B) or the person who listed the diamond for sale (Scenario C).

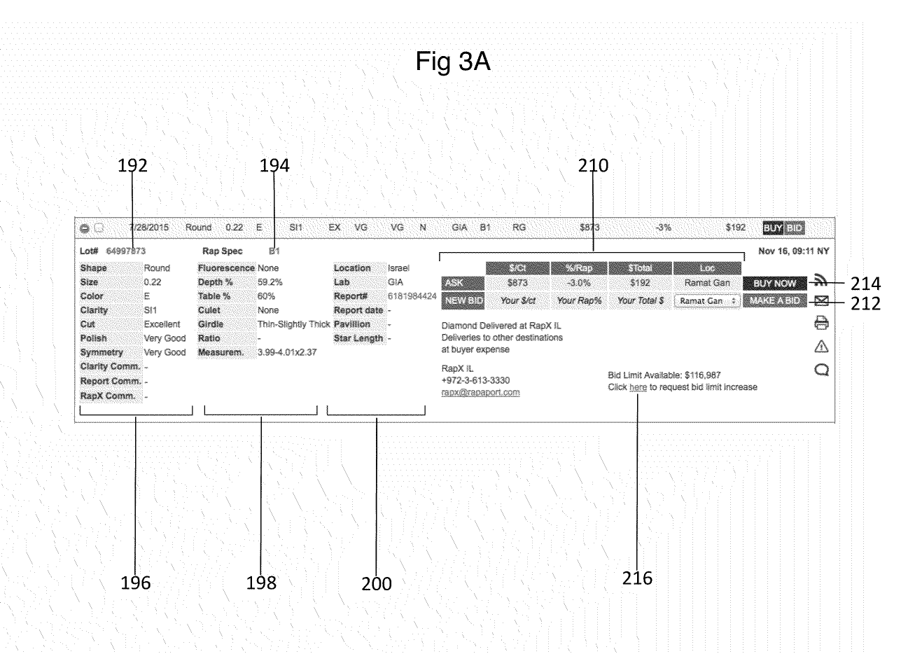

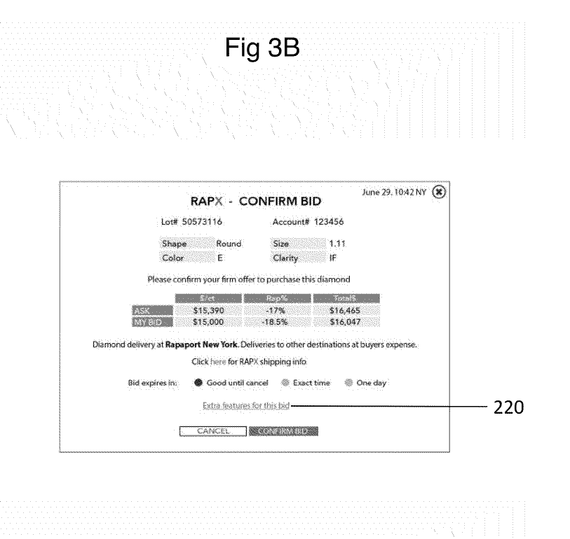

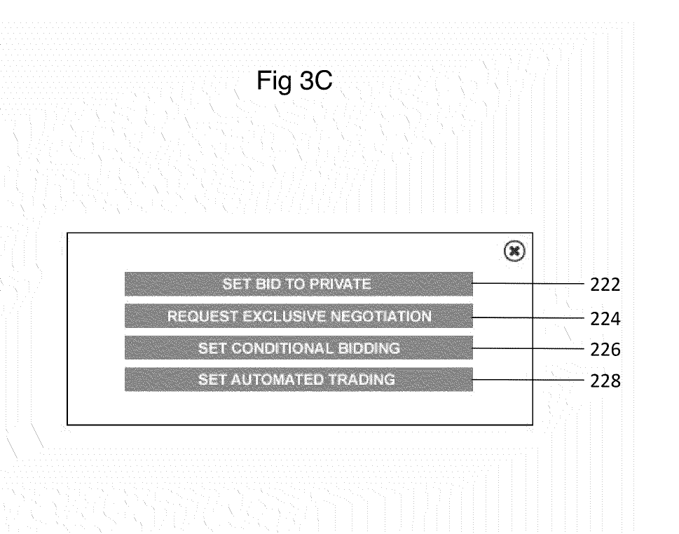

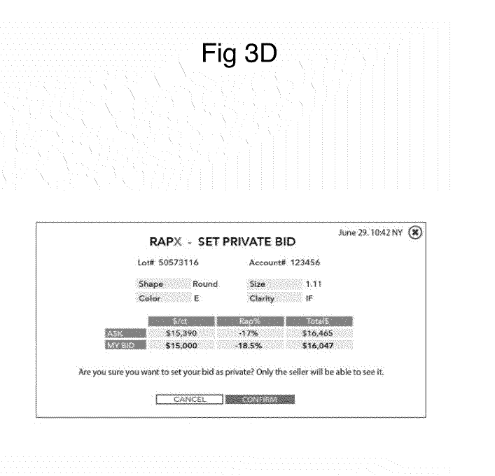

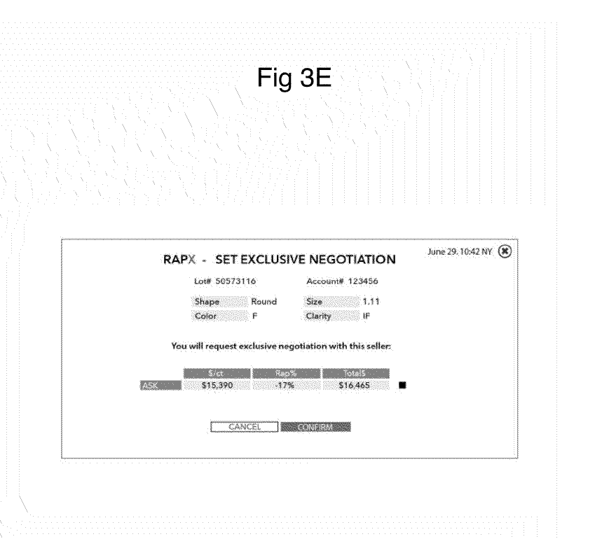

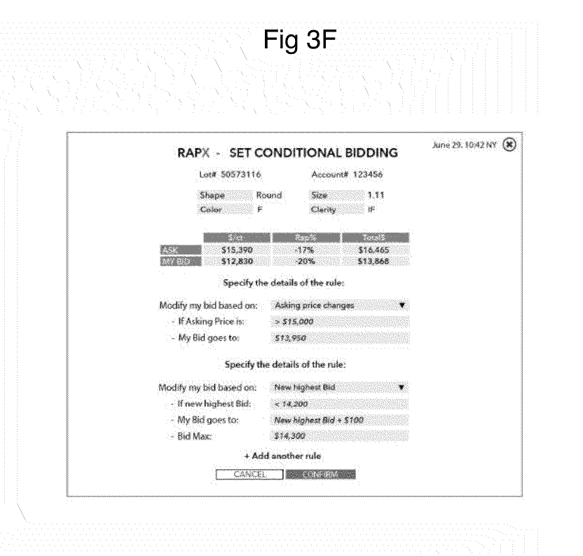

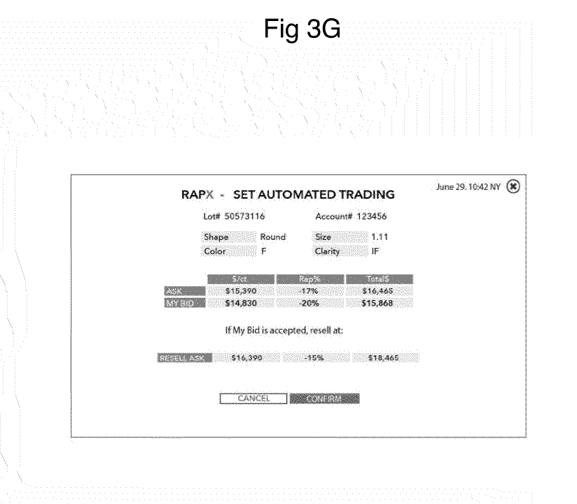

Preferably, when a user clicks on any of icons 176, 178 and 180 on a given line, here designated as a line 190, representing a given diamond, a further screen appears, which typically may be one of three types of screens shown in FIGS. 3A, 4 and 5A respectively. The screens shown in FIGS. 3A, 4 and 5A preferably all have the same general format but contain different types of content. Each of FIGS. 3A, 4 and 5A as well as various other screens described hereinbelow preferably includes a display of the current time and date at a given location, such as New York, and of the user's account number.

Turning to FIG. 3A, which represents scenario A, it is seen that a selected line resembling selected line 190 from the sequential list 174 of diamonds, appears at the top of the screen. The lot number appears at a location 192 and the Rap Spec appears at a location 194. A table 196 preferably includes information as to shape, size, color, clarity, cut, polish and symmetry and also may include comments inserted by sellers as to clarity or other parameters as well as comments inserted by operators of the system. An additional table 198 includes information as to fluorescence, depth %, table %, culet, girdle, ratio and measurements.

A further table 200 includes information as to delivery location, certification laboratory, certification report number and date, pavillion and star length. A transaction table 210 indicates price/ct., % of the price, such as the price set forth in Rapaport Diamond Report pricelist, total diamond price and delivery location corresponding to an offered diamond, designated by ASK. Transaction table 210 additionally indicates a new bid, which can be entered at a NEW BID location and by then clicking on a MAKE A BID icon 212. A user can purchase the diamond as per the offered price and delivery parameters by clicking on a BUY NOW icon 214 or can make a bid, as per the data entered by the user at the NEW BID location before clicking on the MAKE A BID icon 212. It is appreciated that a user can indicate his bid as either an amount per carat, an amount per diamond or a percentage of the price, such as the price set forth in Rapaport Diamond Report pricelist. The system automatically translates the bid into all of the other formats. If a previous bid has been made by another user for the selected diamond, the particulars of that bid are displayed alongside a TOP BID location (not shown). The screen of FIG. 3A also indicates a bid limit amount applicable to the user and a hyperlink 216 to request a bid limit increase.

When a user clicks on icon 212, a bid confirmation screen, as shown in FIG. 3B, is displayed. As seen in FIG. 3B, the bid confirmation screen typically shows a display including a summary of the diamonds' gemological information, transaction information and a hyperlink 220, which allows the user to edit extra features for the bid.

When a user clicks on hyperlink 220, an Extra features screen, as shown in FIG. 3C, is displayed. As seen in FIG. 3C, the Extra features screen typically shows a display including a number of extra features that can be edited for the bid, including hyperlinks 222, 224, 226 and 228.

When a user clicks on hyperlink 222, a Set Bid to Private screen, as shown in FIG. 3D, is displayed. As seen in FIG. 3D, the Set Bid to Private screen typically shows a display including a summary of the diamonds' gemological information, and the option for the user to set the bid to private. When a user clicks on hyperlink 224, a Set Exclusive Negotiation screen, as shown in FIG. 3E, is displayed. As seen in FIG. 3E, the Set Exclusive Negotiation screen typically shows a display including a summary of the diamonds' gemological information, and the option for the user to set exclusive negotiation with the seller.

When a user clicks on hyperlink 226, a Set Conditional Bidding screen, as shown in FIG. 3F, is displayed. As seen in FIG. 3F, the Set Conditional Bidding screen typically shows a display including a summary of the diamonds' gemological information, and the option for the user to set conditional bidding based on different events. When a user clicks on hyperlink 228, a Set Automated Trading screen, as shown in FIG. 3G, is displayed. As seen in FIG. 3G, the Set Automated Trading screen typically shows a display including a summary of the diamonds' gemological information, and the option for the user to set automated trading.

It is a particular feature of a preferred embodiment of the present invention that identities of the selling users offering the diamonds for sale are not known to the buying user participating in the above-described trading scenario A.

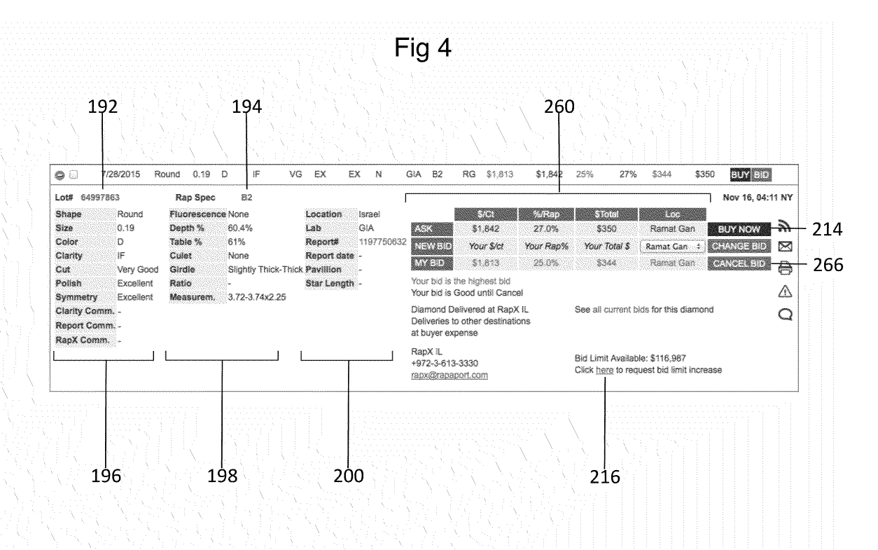

Turning now to FIG. 4, which represents scenario B, it is seen that the selected line 190 from the sequential list 174 of diamonds appears at the top of the screen. The lot number appears at location 192 and the Rap Spec appears at location 194. Table 196 preferably includes information as to shape, size, color, clarity, cut, polish and symmetry and also may include comments inserted by sellers as to clarity or other parameters as well as comments inserted by operators of the system. Additional table 198 includes information as to fluorescence, depth %, table %, culet, girdle, ratio and measurements. Further table 200 includes information as to delivery location, certification laboratory, certification report number and date, pavillion and star length.

Instead of transaction subscreen 210 seen in FIG. 3A, there is here provided an alternative transaction subscreen 260, which indicates price/et., % of the price, such as the price set forth in Rapaport Diamond Report pricelist, total diamond price and delivery location corresponding to an offered diamond, designated by ASK, a new bid, which can be entered at a NEW BID location and a previous bid of the user, designated by MY BID. The user's previous bid can be canceled by the user by clicking on the CANCEL BID icon 266.

A user can purchase the diamond as per the offered price and delivery parameters by clicking on the BUY NOW icon 214 and can make a new bid replacing the user's previous bid, as per the data entered by the user after clicking on the NEW BID location. It is appreciated that a user can indicate his bid as either an amount per carat, an amount per diamond or a percentage of the price, such as the price set forth in Rapaport Diamond Report pricelist. The system automatically translates the bid into all of the other formats.

If a previous bid has been made by another user for the selected diamond and is higher than the user's previous bid, the particulars of the other user's bid are displayed alongside a TOP BID location (not shown). The screen of FIG. 4 also indicates a bid limit amount applicable to the user and includes hyperlink 216 to request a bid limit increase. If the user's previous bid is the highest bid for the selected diamond, a statement to that effect may appear.

It is a particular feature of a preferred embodiment of the present invention that identities of the selling users offering the diamonds for sale are not known to the buying user participating in the above-described trading scenario B.

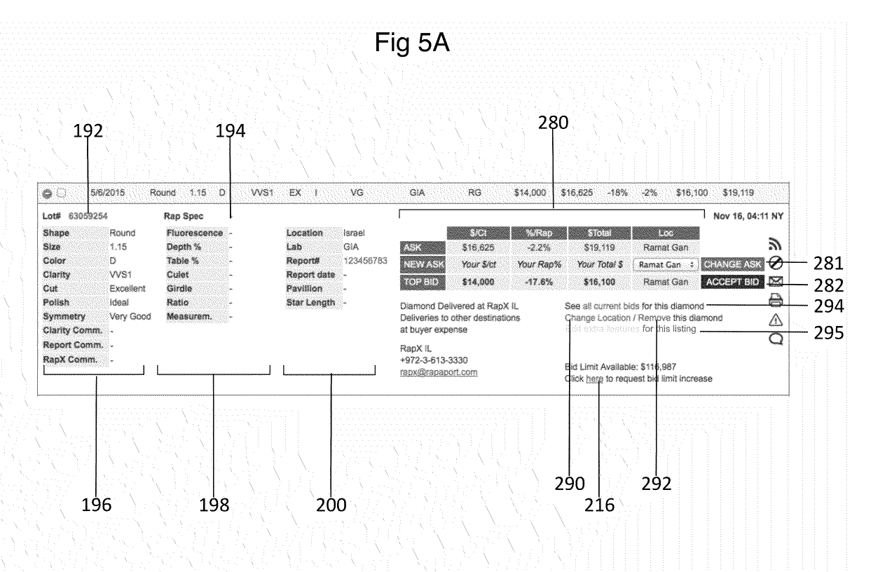

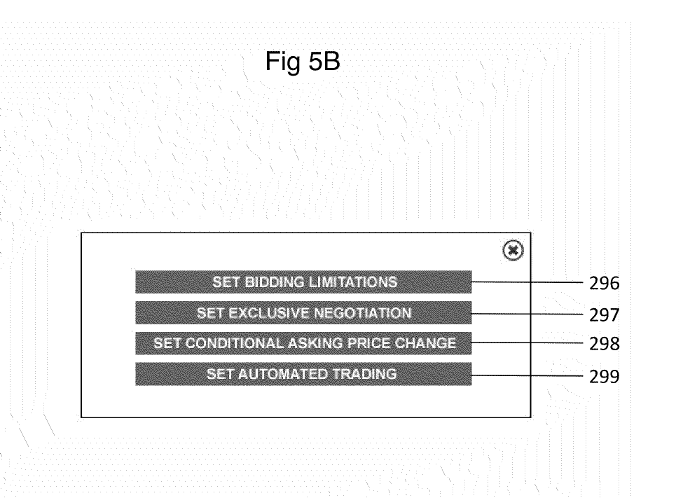

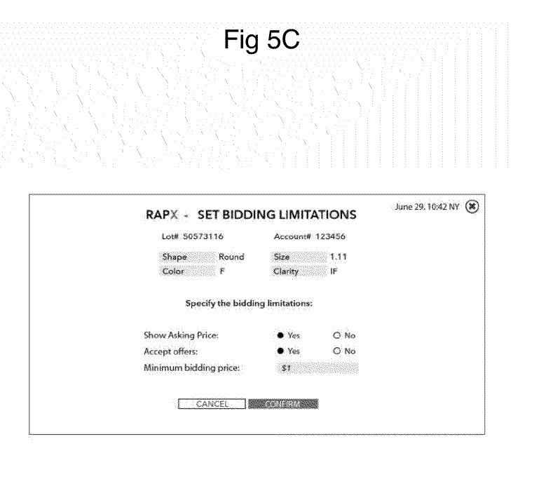

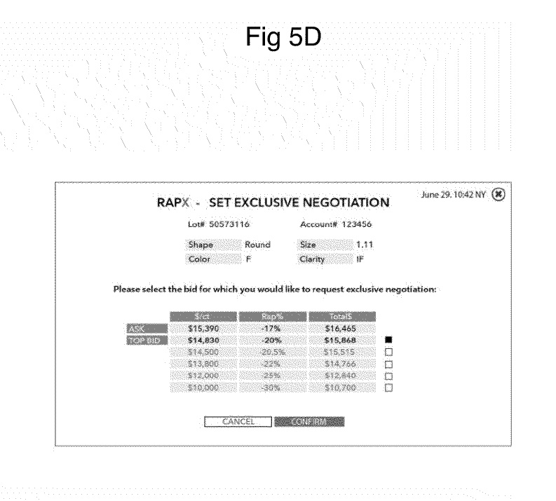

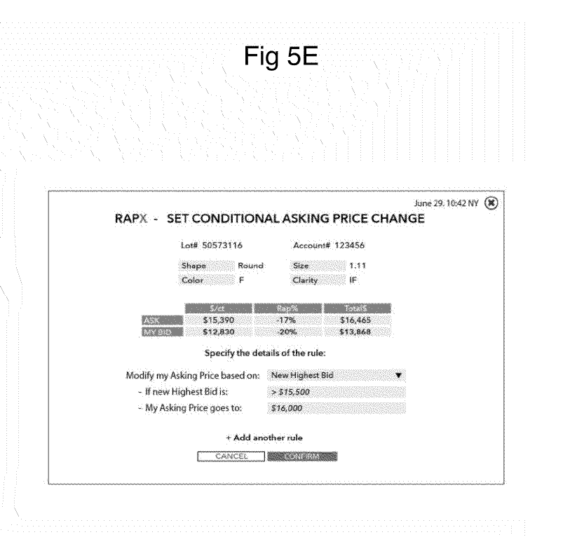

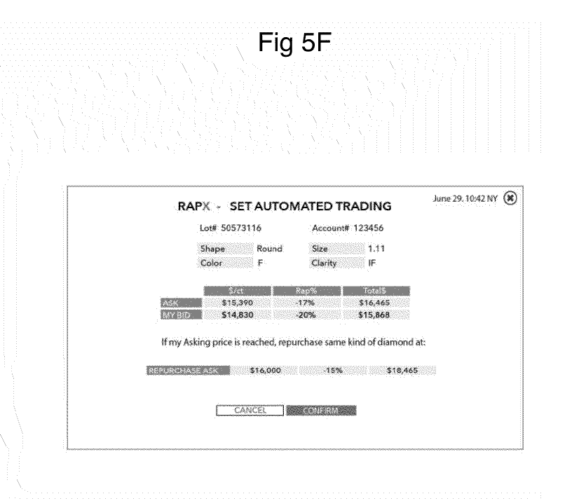

Turning now to FIG. 5A, which represents scenario C, it is seen that a line resembling selected line 190 from the sequential list 174 of diamonds appears at the top of the screen. The lot number appears at location 192 and the Rap Spec appears at location 194. Table 196 preferably includes information as to shape, size, color, clarity, cut, polish and symmetry and also may include comments inserted by sellers as to clarity or other parameters as well as comments inserted by operators of the system. Additional table 198 includes information as to fluorescence, depth %, table %, culet, girdle, ratio and measurements. Further table 200 includes information as to delivery location, certification laboratory, certification report number and date, pavillion and star length.

Instead of transaction subscreens 210 and 260 respectively seen in FIGS. 3A and 4, there is here provided an alternative transaction subscreen 280, which indicates the seller's asking price/ct., % of the price, such as the price set forth in Rapaport Diamond Report pricelist, total diamond price and delivery location corresponding to an offered diamond, designated by ASK. In this case, the user is the seller. A revised asking price can be entered by the user, who is the seller, by clicking on a CHANGE ASK location 281. The highest bid for the diamond that is on the system appears alongside the TOP BID location.

A user, who is the seller, can sell the diamond as per the top bid by clicking on an ACCEPT BID icon 282. It is appreciated that a bid can be entered as an amount per carat, an amount per diamond or a percentage of the price, such as the price set forth in Rapaport Diamond Report pricelist. The system automatically translates the bid into all of the other formats. The screen of FIG. 5A also indicates a bid limit amount applicable to the user and includes hyperlink 216 to request a bid limit increase.

Preferably, the screen of FIG. 5A includes a hyperlink 290 which enables the user/seller to change the delivery location, a further hyperlink 292 which enables the user/seller to remove the diamond from the system and an additional hyperlink 294 which displays all bids on the diamond. A further Edit Extra features hyperlink 295 is also preferably included.

When a user clicks on hyperlink 295, an Extra features screen, as shown in FIG. 5B, is displayed. As seen in FIG. 5B, the Extra features screen typically shows a display including a number of extra features that can be edited for the listing, including hyperlinks 296, 297, 298 and 299. When a user clicks on hyperlink 296, a Set Bid Limitations screen, as shown in FIG. 5C, is displayed. As seen in FIG. 5C, the Set Bid Limitations screen typically shows a display including a summary of the diamonds' gemological information, and the option for the seller to set bidding limitations.

When a user clicks on hyperlink 297, a Set Exclusive Negotiation screen, as shown in FIG. 5D, is displayed. As seen in FIG. 5D, the Set Exclusive Negotiation screen typically shows a display including a summary of the diamonds' gemological information, and the option for the seller to set exclusive negotiation with the buyer. When a user clicks on hyperlink 298, a Set Conditional Asking Price Change screen, as seen in FIG. 5E, is displayed. As seen in FIG. 5E, the Set Conditional Asking Price Change screen typically shows a display including a summary of the diamonds' gemological information, and the option for the seller to set conditional Asking Price Change based on different events. When a user clicks on hyperlink 299, a Set Automated Trading screen, as seen in FIG. 5F, is displayed. As seen in FIG. 5F, the Set Automated Trading screen typically shows a display including a summary of the diamonds' gemological information, and the option for the seller to set automated trading.

It is a particular feature of a preferred embodiment of the present invention that identities of buying users bidding for or buying diamonds offered for sale are not known to a selling user participating in the above-described trading scenario C. It is thus appreciated that the above-described screens shown in FIGS. 3A-5F represent computerized deal making functionality enabling a buying user to make a deal with a selling user by making a bid which matches an asking price and enabling a selling user to make a deal with a buying user by accepting a bid, wherein identities of the buying user and selling user participating in the deal are not known to each other.

Turning back to FIG. 1 and specifically to secondary menu bar 102, it is noted that although the foregoing description is directed to an example where ALL DIAMOND LISTINGS has been selected, it is applicable also to a situation wherein any of ALL DIAMOND LISTINGS, MY DIAMONDS FOR SALE, MY DIAMONDS WITH BIDS, MY BIDS, ALL DIAMOND BIDS, TRACKED DIAMONDS, ADD DIAMONDS is selected. Differences in the screens which appear in cases where a different second-level menu item is selected reflect various database filterings.

Specifically, for MY DIAMONDS FOR SALE, only diamonds corresponding to Scenario C appear. For MY DIAMONDS WITH BIDS, only diamonds corresponding to Scenario C and for which there are bids of other users appear. This case is a subset of the preceding case. For MY BIDS, only diamonds corresponding to Scenario B appear. For ALL DIAMOND BIDS, only diamonds having bids appear. For TRACKED DIAMONDS, only diamonds tracked by the user appear. For ADD DIAMONDS an informational guide to listing diamonds for sale appears.

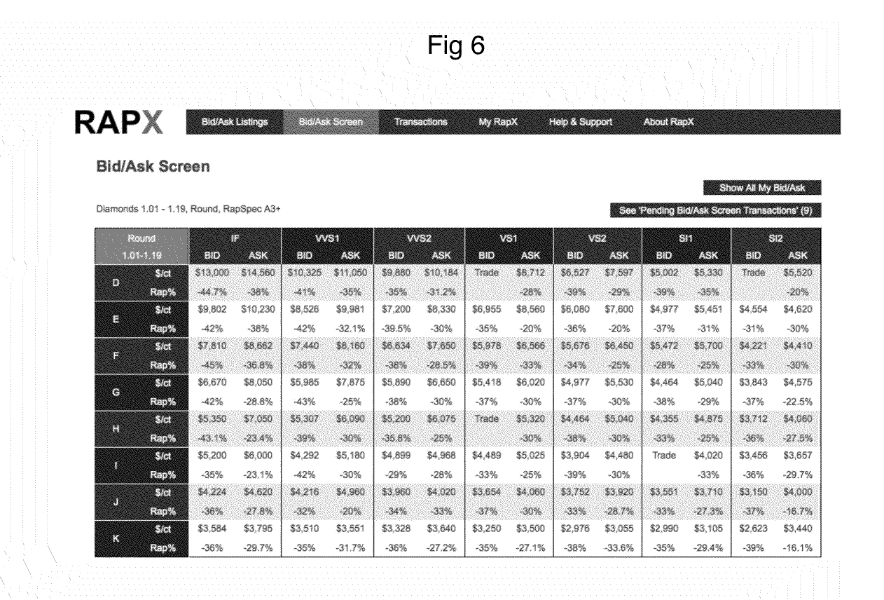

The following description relates to operation of the system when the BID/ASK SCREEN menu item in top menu bar 100 is selected. A typical BID/ASK SCREEN appears in FIG. 6 and preferably displays information for categories of diamonds within a predetermined range of diamond weights, shapes, color scale and clarity scale. In this example, only categories of round diamonds within a weight range of 1.01-1.19 carats appear and these categories are arranged according to the color scale and clarity scale. Preferably, all of the diamond categories appearing in the screen of FIG. 6 have the same RAPSPEC. For each diamond category, there appear both bid and ask prices in US$ and as a percentage of the Rapaport Diamond Report pricelist.

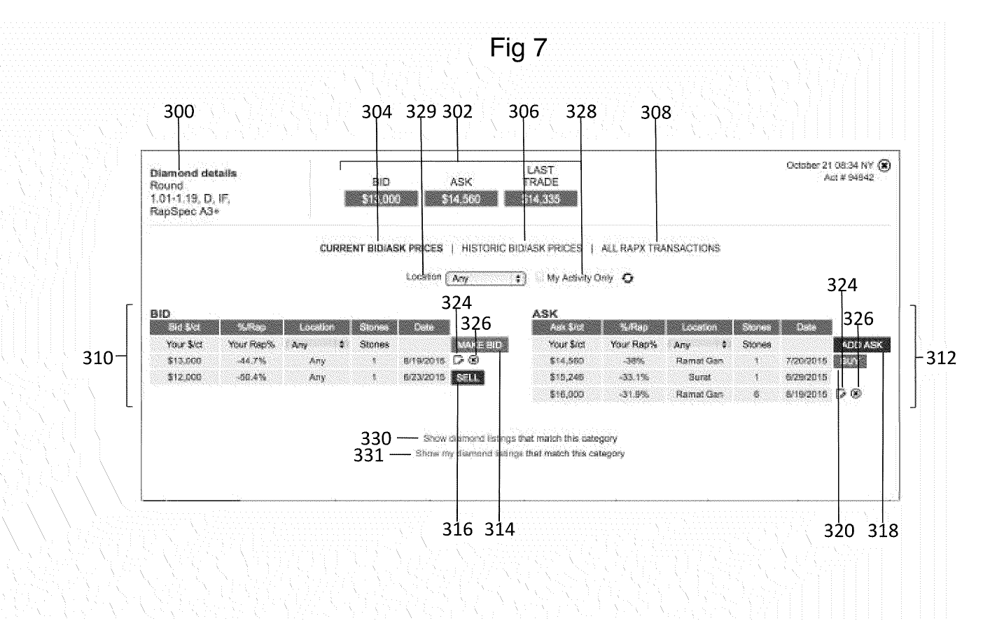

It is appreciated that the BID/ASK screen shown in FIG. 6 thus represents computerized listing functionality, providing to users a listing of asking prices and bid prices for a multiplicity of items, the items being here embodied, by way of example, as diamonds. Each of the categories in the screen of FIG. 6 is a hyperlink and when clicked on displays a screen of the type shown in FIG. 7.

As seen in FIG. 7 the screen includes a location 300 which describes the category, preferably specifying the diamond weight, shapes color scale and clarity scale of the category and its RAPSPEC. There is also provided at a location 302 an indication of the highest bid price, the lowest asking price and the price of the last transaction for this category in the system, which are designated respectively as BID, ASK and LAST TRADE.

There are preferably provided three hyperlinks, 304, 306 and 308, enabling a user to display current bid/ask prices, historic bid/ask prices and all RAPX transactions for the selected category. In the illustrated example, which represents a default selection, current bid/ask prices are displayed at locations 310 and 312 respectively.

The table at location 310 preferably lists all the bids in the system for the selected category of diamonds, arranged from the highest bid to the lowest bid. The number of diamonds under bid is also indicated. The table at location 312 preferably lists all the asking prices in the system for the selected category of diamonds, arranged from the lowest asking price to the highest asking price. The number of diamonds offered for sale for the given asking price is also indicated.

Referring to location 310, it is appreciated that a buying user may add a bid by clicking on a MAKE BID icon 314. It is further appreciated that a selling user may sell one or more diamonds in response to a specific bid indicated at location 310 by simply clicking on a SELL icon 316. Referring to location 312, it is appreciated that a selling user may add an asking price by clicking on an ADD ASKING PRICE icon 318. It is further appreciated that a buying user may buy one or more diamonds in response to a specific ask indicated at location 312 by simply clicking on a BUY icon 320.

If a user has placed a bid or has entered an asking price, that user will view either of icons 324 (Edit) and 326 (Delete) in place of the previously mentioned icon. A My Activity Only checkbox 328, which is unchecked in a default state, allows the user to display only the bids and asking prices placed by that user. A SHOW DIAMOND LISTINGS THAT MATCH THIS CATEGORY hyperlink 330, when clicked, displays a list, similar to that shown in FIG. 2, of the diamonds in the system which fall within the category appearing at location 300 and meeting the delivery location criteria entered in a menu 329. A SHOW MY DIAMOND LISTINGS THAT MATCH THIS CATEGORY hyperlink 331 when clicked, displays a list, similar to that shown in FIG. 2, of the diamonds in the system that the user has previously listed which fall within the category appearing at location 300 and meeting the delivery location criteria entered in menu 329.

It is appreciated that the screen shown in FIG. 7 thus represents computerized deal making functionality enabling a buying user to make a deal with a selling user by making a bid which matches an asking price and enabling the selling user to make a deal with the buying user by accepting the bid, wherein identities of said buying user and said selling user are preferably not known to each other.

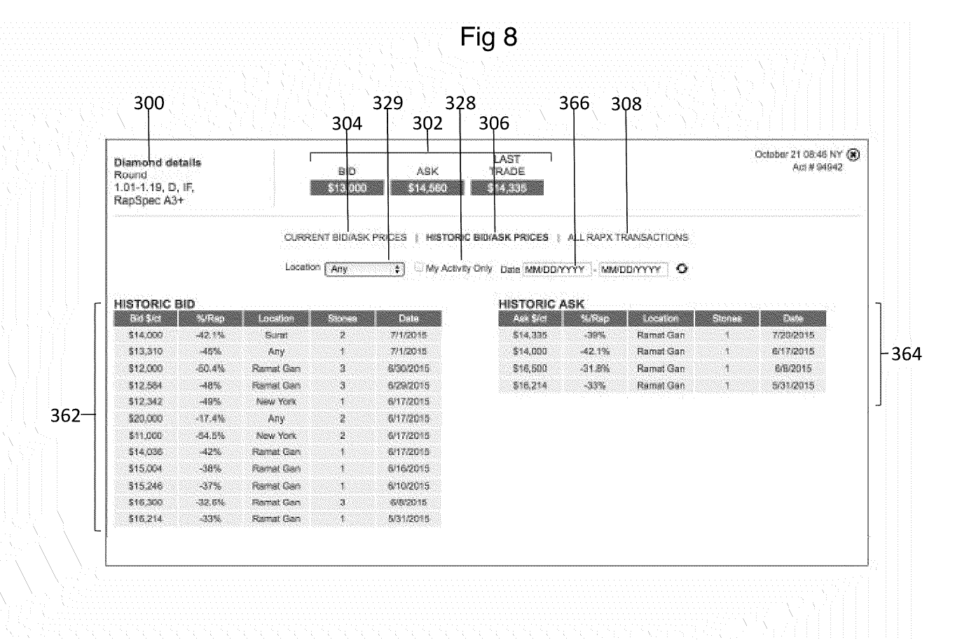

If the user clicks on the HISTORIC BID/ASK PRICES hyperlink 306 in FIG. 7, a screen of the type shown in FIG. 8 appears. As seen in FIG. 8, the screen includes location 300, which describes the category, preferably specifying the diamond weight, shapes color scale and clarity scale of the category and its RAPSPEC. There is also provided, at location 302, an indication of the highest bid price, the lowest asking price and the price of the last transaction for this category in the system, which are designated respectively as BID, ASK and LAST TRADE.

There are preferably provided three hyperlinks, 304, 306 and 308, enabling a user to display current bid/ask prices, historic bid/ask prices and all RAPX transactions for the selected category. In the illustrated example historic bid/ask prices are displayed at locations 362 and 364 respectively.

The table at location 362 preferably lists all of the historic bids in the system, including only canceled and expired bids, for the selected category of diamonds, arranged from the highest bid to the lowest bid. The number of diamonds historically under bid is also indicated. The table at location 364 preferably lists all of the historic asking prices in the system for the selected category of diamonds, arranged from the lowest asking price to the highest asking price. The number of diamonds historically offered for sale for the given asking price is also indicated.

The My Activity Only checkbox 328, which is shown in an unchecked state, allows a user to display only the historic bids and historic asking prices placed by that user. The DELIVERY LOCATION menu 329 allows the user to select a specific historic delivery location for the historic Bid and Asking Prices appearing in locations 362 and 364 respectively. A date panel 366 enables a user to enter a range of dates which can be used to filter the results appearing at locations 362 and 364.

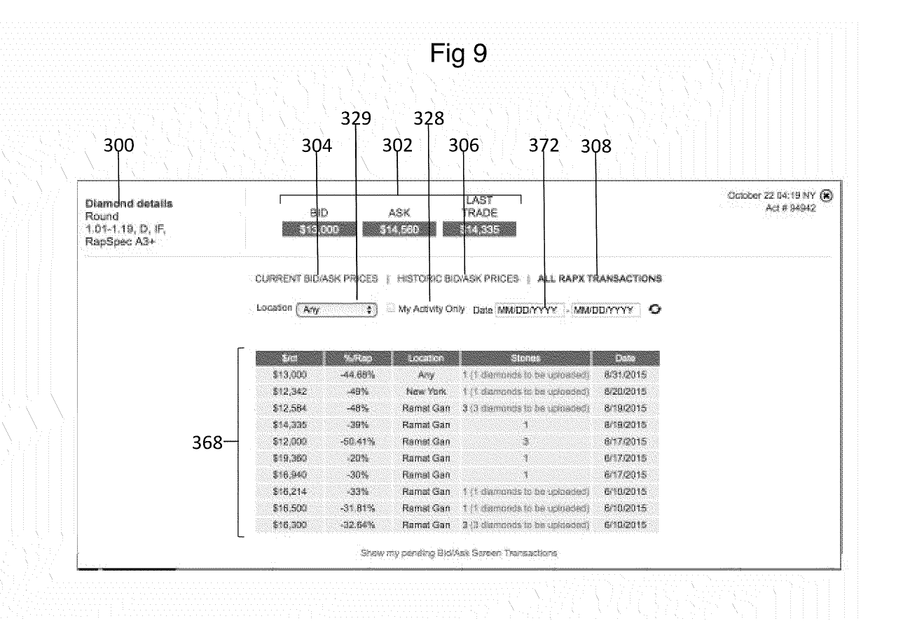

If the user clicks on the ALL RAPX TRANSACTIONS hyperlink 308 in FIG. 7 or 8, a screen of the type shown in FIG. 9 appears. As seen in FIG. 9, the screen includes location 300 which describes the category, preferably specifying the diamond weight, shapes, color scale and clarity scale of the category and its RAPSPEC. There is also provided, at location 302, an indication of the highest bid price, the lowest asking price and the price of the last transaction for this category in the system, which are designated respectively as BID, ASK and LAST TRADE.

There are preferably provided three hyperlinks, 304, 306 and 308, enabling a user to display current bid/ask prices, historic bid/ask prices and all RAPX transactions for the selected category, respectively. In the illustrated example, All RapX Transactions are displayed at a location 368. A RapX Transaction is deemed to exist once the system matches a willing buyer and a willing seller for one or more diamonds offered for sale or purchase, such that a deal may be made between the buyer and seller. Such a transaction is preferably implemented by computerized deal implementing functionality operative following the making of the deal, for transferring payment relating to the deal as per the buyer's bid and seller's asking price, from the buyer to the seller via an account administered by the computerized deal implementing functionality and for transferring the one or more diamonds which are the subject of the deal from the seller to the buyer via a physical facility controlled by the computerized deal implementing functionality. Such a physical facility, may be, by way of example, an office or warehouse. The transaction is deemed to be cleared, once the one or more diamonds have been delivered and the payment has been received.

The table at location 368 preferably lists all the RAPX transactions carried out through the Bid/Ask Screen for the selected category of diamonds, arranged by date. The number of diamonds per transaction is also indicated. DELIVERY LOCATION menu 329 allows the user to select transactions having a specific delivery location among all of the transactions appearing at location 368. My Activity Only checkbox 328, which is shown in an unchecked state, allows a user to display only the transactions in which that user participated as a buyer or a seller. A date panel 372 enables a user to enter a range of dates which can be used to filter the results appearing at locations 368.

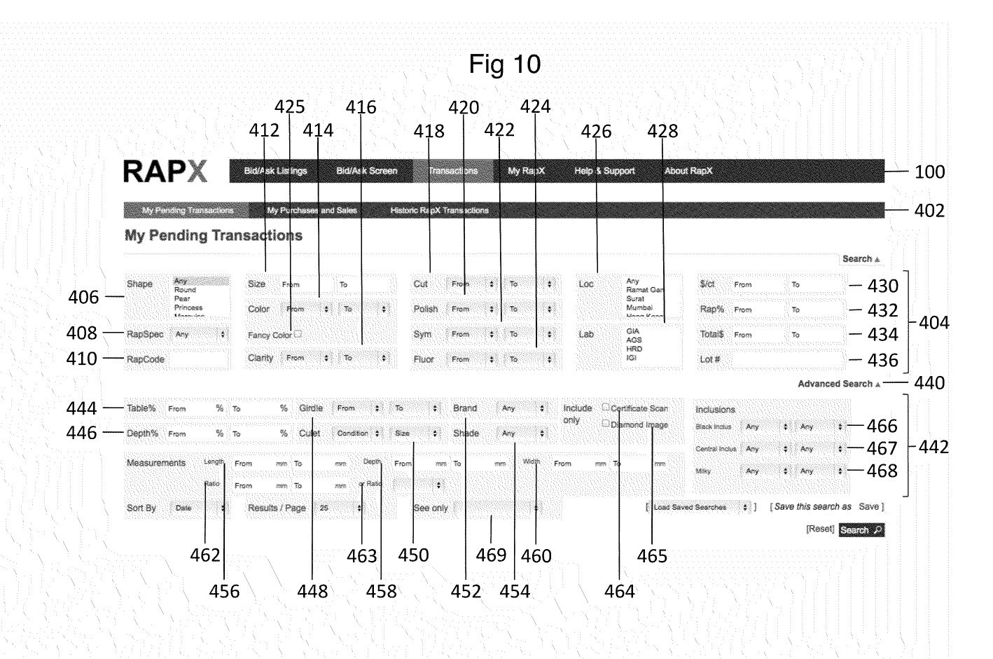

Reference is now made to FIG. 10, which relates to operation of the system when the TRANSACTION menu item in top menu bar 100 is selected. A typical TRANSACTION screen appears in FIG. 10.

Preferably below top menu bar 100 is a secondary menu bar 402. In this case, the secondary menu bar 402 shows the following second-level menu items for the top menu item TRANSACTIONS: MY PENDING TRANSACTIONS, MY PURCHASES AND SALES, HISTORIC RAPX TRANSACTIONS. Preferably, the default initial screen when selecting TRANSACTIONS indicates a selection of MY PENDING TRANSACTIONS. MY PENDING TRANSACTIONS lists the diamonds a specific user has agreed to buy or sell in a transaction, which has not yet cleared, i.e. either the diamond has not yet been delivered or the payment has not yet been received.

Preferably below secondary menu bar 402 is a searchable array 404, which allows a user to filter the list of diamonds in a transaction, which has not yet cleared. The searchable array 404 preferably includes a sub-array 406, enabling searching by diamond shape, a sub-array 408, enabling searching by RapSpec and a sub-array 410, enabling searching by RapCode. RapSpec and Rap Code are parameters which are known in the art and are implemented in the prior art Rapaport Diamond Trading Network, commonly known as RapNet. The searchable array 404 also preferably includes subarrays 412, 414 and 416, which enable searching by size, color and clarity, respectively, and subarrays 418, 420, 422 and 424, which enable searching by cut, polish, symmetry and fluorescence, respectively. The searchable array 404 also preferably includes a Fancy Color check box 425.

The searchable array 404 also preferably includes subarrays 426 and 428, which enable searching by delivery location and certification laboratory. The searchable array 404 also includes subarrays 430, 432, 434 and 436, which enable searching by price/carat, % percentage price difference, such as difference from the price set forth in Rapaport Diamond Report pricelist, total price and lot #, respectively.

Below searchable array 404 is an icon 440, allowing a user to access an advance search functionality. Clicking on icon 440 causes an advanced search array 442 to appear below searchable array 404. The advanced search array 442 preferably includes subarrays 444, 446, 448, 450, 452 and 454, which enable searching by Table %, Depth %, Girdle, Culet, Brand and Shade, respectively. The advanced search array 442 preferably also includes subarrays 456, 458, 460, 462 and 463, which enable searching by length, depth, width, and ratio respectively. The advanced search array 442 also preferably includes two check boxes 464 and 465, for certificate scan and diamond image, respectively.

The advanced search array 442 preferably also includes subarrays 466, 467 and 468, which enable searching by numbers of black, central and milky inclusions. A SEE ONLY menu 469 allows a user to filter the list of diamonds according to whether the user is the buyer or the seller in a given transaction. Typically, below advanced search array 442 there appears a default list (not shown) of all the pending purchases and sales of the user in the system in a transaction, which has not yet cleared. This list can be filtered by the user employing searchable array 404 and advanced search array 442.

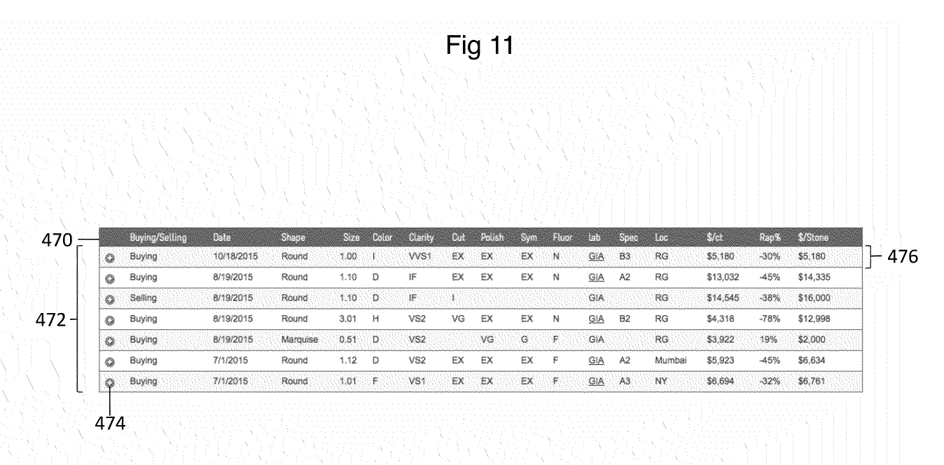

Reference is now made to FIG. 11, which illustrates a search results screen produced by the system as the result of searching using either of searchable arrays 404 and 442. A top line 470 of the search results screen of FIG. 11 lists various parameters which appear in the listings therebelow. Preferably these parameters include Buying/Selling, Date, Shape, Size, Color, Clarity, Cut, Polish, Symmetry, Fluoresence, Certification Laboratory, Rap Spec, Delivery Location, $/Ct amount, % of the price, such as the price set forth in Rapaport Diamond Report pricelist, and total price per diamond. Below the top line 470 is a sequential list 472 of diamonds in a transaction, which has not yet cleared, one line per diamond, in which all relevant ones of the above parameters appear. Additionally, typically at the left side of each line, there appears a clickable+icon 474.

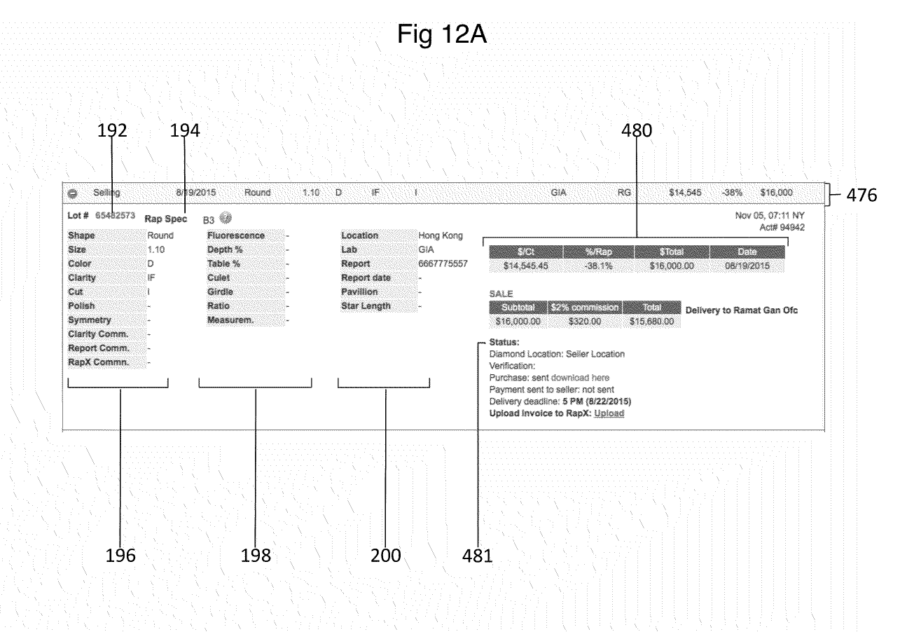

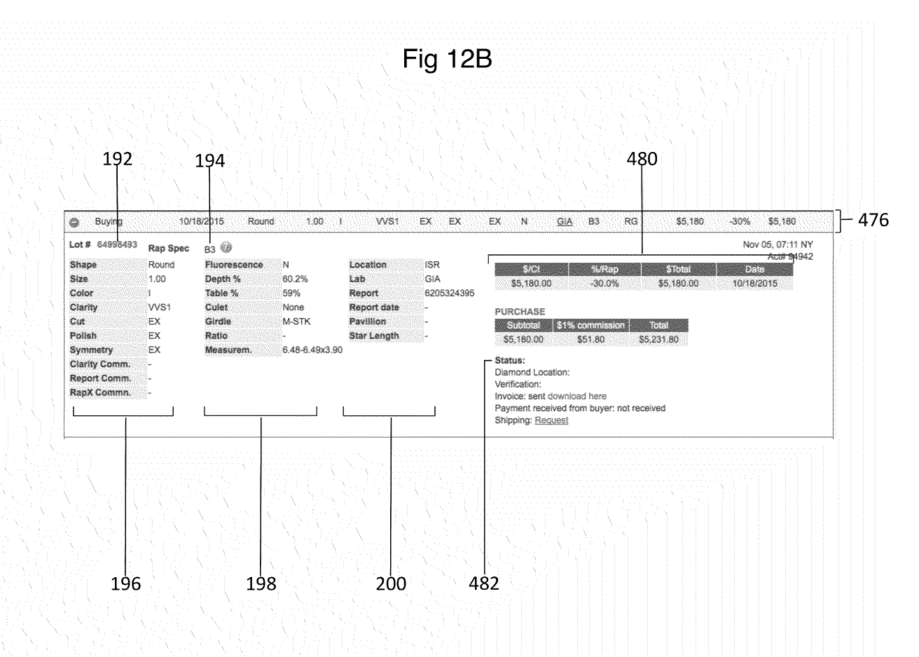

There may be two scenarios at this stage, which reflect the relationship between a given user and a given listed diamond in a given transaction. The user may be buying a diamond (Scenario A), or selling a diamond (Scenario B). It is appreciated that in both scenarios A and B, identities of the buyer user and selling user are preferably not known to each other. By clicking on the +icon 474 for a given line 476 in list 472, the user causes one of two possible screens to appear. If the user is the buyer in the transaction, the screen in FIG. 12A will appear and if the user is the seller in the transaction, the screen in FIG. 12B will appear.

Turning now to FIG. 12A, which represents scenario A, it is seen that a line resembling the selected line 476 from the sequential list 472 of diamonds appears at the top of the screen. The lot number appears at location 192 and the Rap Spec appears at location 194. Table 196 preferably includes information as to shape, size, color, clarity, cut, polish and symmetry and also may include comments inserted by sellers as to clarity or other parameters as well as comments inserted by operators of the system. Additional table 198 includes information as to Fluorescence, Depth %, Table %, Culet, Girdle, Ratio and Measurements. Further table 200 includes information as to delivery location, certification laboratory, certification report number and date, pavillion and star length. An additional table 480 includes the following transaction parameters for a given line 476 in list 472 appearing in FIG. 11: Price per carat, price as a percentage of the Rapaport Diamond Report pricelist and total price per diamond.

Beneath table 480, there is preferably provided information concerning implementation of the transaction, listed at a location 481 under the title ‘Status’. The listed status of the transaction includes information relating to transfer of payment for the transaction via an account administered by computerized deal implementing functionality, as indicated, by way of example, by entries at ‘Purchase’ and ‘Payment sent to seller’. The listed status of the transaction also includes information relating to transfer of the diamonds which are the subject of the transaction via a physical facility controlled by the computerized deal implementing functionality, as indicated, by way of example, by entries at ‘Diamond Location’ and ‘Delivery Deadline’.

Turning now to FIG. 12B, which represents scenario B, it is seen that the selected line 476 from the sequential list 472 of diamonds appears at the top of the screen. The lot number appears at location 192 and the Rap Spec appears at location 194. Table 196 preferably includes information as to shape, size, color, clarity, cut, polish and symmetry and also may include comments inserted by sellers as to clarity or other parameters as well as comments inserted by operators of the system. Additional table 198 includes information as to fluorescence, depth %, table %, culet, girdle, ratio and measurements. Further table 200 includes information as to delivery location, certification laboratory, certification report number and date, pavillion and star length. Additional table 480 includes the following transaction parameters for a given line 476 in list 472 appearing in FIG. 11: Price per carat, price as a percentage of the Rapaport Diamond Report pricelist and total price per diamond.

Beneath table 480, there is preferably provided information concerning implementation of the transaction, listed at a location 482 under the title ‘Status’. The listed status of the transaction includes information relating to transfer of payment for the transaction via an account administered by computerized deal implementing functionality, as indicated, by way of example, by entries at ‘Invoice’ and ‘Payment received from buyer’. The listed status of the transaction also includes information relating to transfer of the diamonds which are the subject of the transaction via a physical facility controlled by the computerized deal implementing functionality, as indicated, by way of example, by entries at ‘Diamond Location’ and ‘Shipping’.

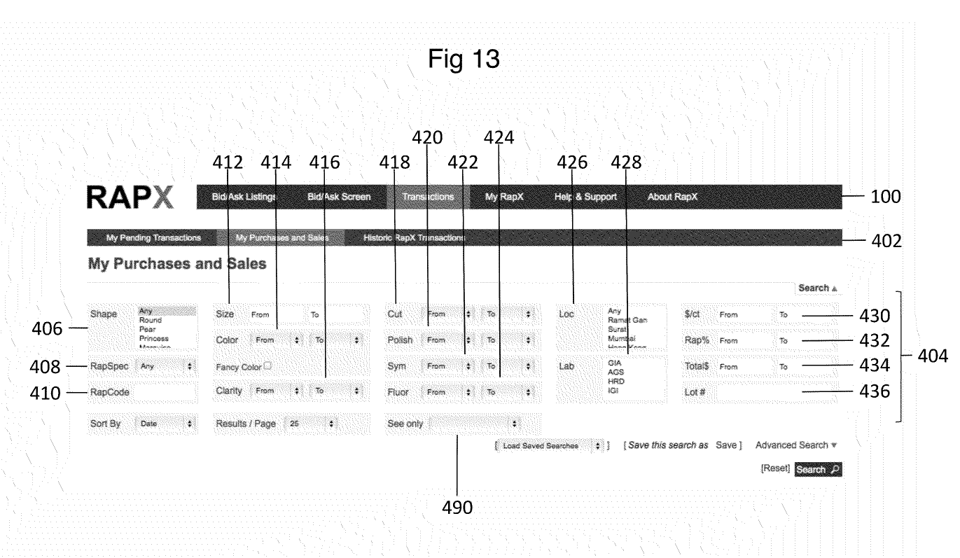

Reference is now made to FIG. 13, which includes top menu bar 100 and secondary menu bar 402 therebelow. In this case, the secondary menu bar 402 shows the following second-level menu items for the top menu item TRANSACTIONS: MY PENDING TRANSACTIONS, MY PURCHASES AND SALES, HISTORIC RAPX TRANSACTIONS.

The screen shows a selection of the menu item MY PURCHASES AND SALES. MY PURCHASES AND SALES lists the diamonds a specific user has purchased or sold in a transaction, which has already cleared.

Preferably below secondary menu bar 402 is searchable array 404, which allows a user to filter the list of diamonds in a transaction, which has already cleared. The searchable array 404 preferably includes sub-array 406, enabling searching by diamond shape, sub-array 408, enabling searching by RapSpec and sub-array 410, enabling searching by RapCode. RapSpec and Rap Code are parameters which are known in the art and are implemented in the prior art Rapaport Diamond Trading Network, commonly known as RapNet. The searchable array 404 also preferably includes subarrays 412, 414 and 416, which enable searching by size, color and clarity respectively and subarrays 418, 420, 422 and 424, which enable searching by cut, polish, symmetry and fluorescence, respectively.

The searchable array 404 also preferably includes subarrays 426 and 428, which enable searching by delivery location and certification laboratory. The searchable array 404 also includes subarrays 430, 432, 434 and 436, which enable searching by price/carat, % percentage price difference, such as difference from the price set forth in the Rapaport Diamond Report pricelist, total price and lot 4, respectively. A SEE ONLY menu 490 allows a user to filter the list of diamonds according to whether the user was the buyer or the seller in a given transaction.

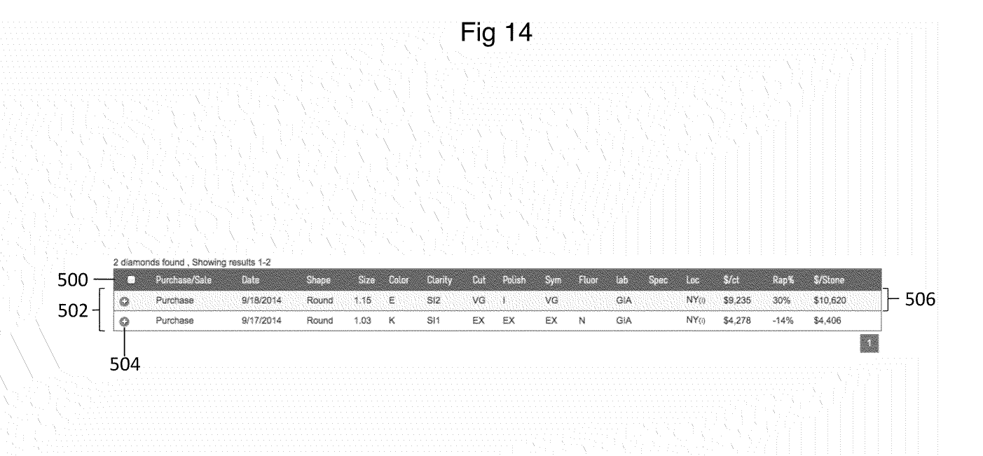

Reference is now made to FIG. 14, which illustrates a search results screen produced by the system as the result of searching using searchable array 404 in the screen of FIG. 13. A top line 500 of the search results screen of FIG. 14 lists various parameters which appear in the listings therebelow. Preferably, these parameters include Purchase/Sale Date, Shape, Size, Color, Clarity, Cut, Polish, Symmetry, Fluorescence, Certification Laboratory, Rap Spec, Delivery Location, $/Ct amount, % of the price, such as a price set forth in Rapaport Diamond Report pricelist, and Total price per diamond. Below the top line 500 is a sequential list 502 of diamonds in a transaction, which has already been cleared, one line per diamond, in which all relevant ones of the above parameters appear. Additionally, typically at the left side of each line there appears a clickable+icon 504.

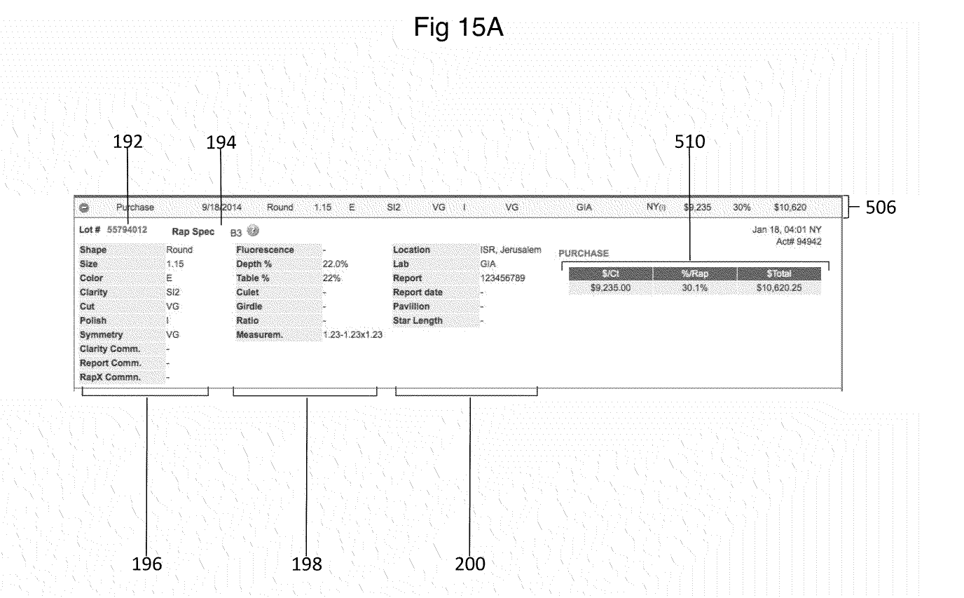

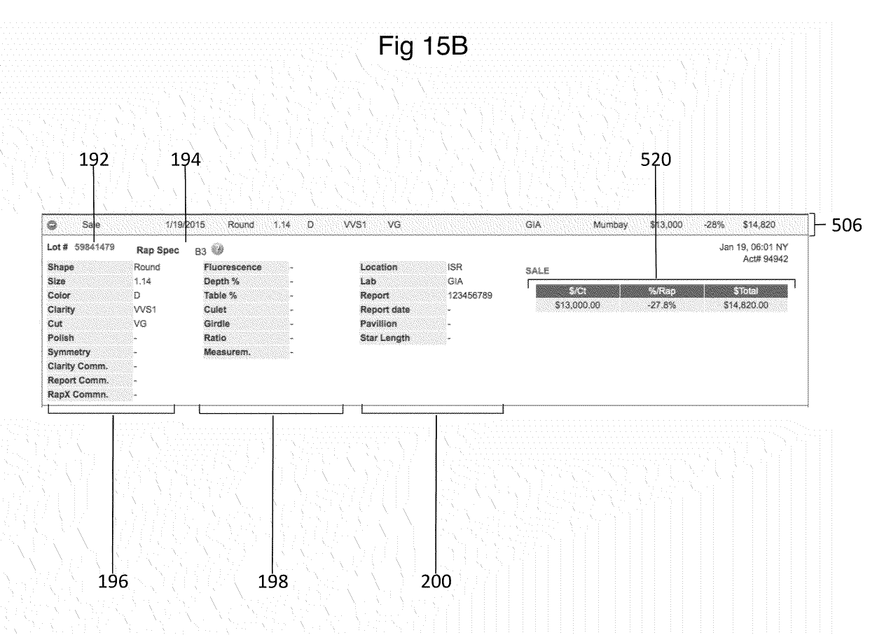

There may be two scenarios at this stage, which reflect the relationship between a given user and a given listed diamond in a given transaction. The user may have sold one or more diamonds (Scenario A), or may have bought one or more diamonds (Scenario B). By clicking on the +icon 504 for a given line 506 in list 502, the user causes one of two possible screens to appear. If the user was the seller in the transaction, the screen in FIG. 15A will appear and if the user was the buyer in the transaction, the screen in FIG. 15B will appear.

Turning now to FIG. 15A, which represents scenario A, it is seen that the selected line 506 from the sequential list 502 of diamonds appears at the top of the screen. The lot number appears at location 192 and the Rap Spec appears at location 194. Table 196 preferably includes information as to shape, size, color, clarity, cut, polish and symmetry and also may include comments inserted by sellers as to clarity or other parameters as well as comments inserted by operators of the system. Additional table 198 includes information as to fluorescence, depth %, table %, culet, girdle, ratio and measurements. Further table 200 includes information as to delivery location, certification laboratory, certification report number and date, pavillion and star length. An additional PURCHASE table 510 includes the following transaction parameters for the given line 506 in list 502 appearing in FIG. 14: Price per carat, price as a percentage of the Rapaport Diamond Report pricelist and total price per diamond.

Turning now to FIG. 15B, which represents scenario B, it is seen that the selected line 506 from the sequential list 502 of diamonds appears at the top of the screen. The lot number appears at location 192 and the Rap Spec appears at location 194. Table 196 preferably includes information as to shape, size, color, clarity, cut, polish and symmetry and also may include comments inserted by sellers as to Clarity or other parameters as well as comments inserted by operators of the system. Additional table 198 includes information as to fluorescence, depth %, table %, culet, girdle, ratio and measurements. Further table 200 includes information as to delivery location, certification laboratory, certification report number and date, pavillion and star length. An additional SALE table 520 includes the following transaction parameters for the given line 506 in list 502, appearing in FIG. 14: Price per carat, price as a percentage of the Rapaport Diamond Report pricelist and total price per diamond.

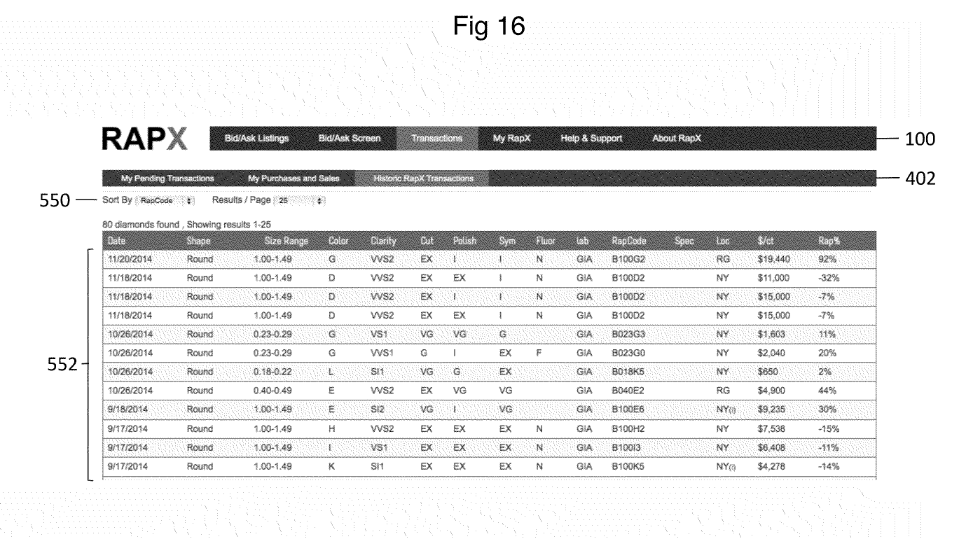

Reference is now made to FIG. 16, which includes top menu bar 100 and therebelow secondary menu bar 402. In this case, the secondary menu bar 402 shows the following second-level menu items for the top menu item TRANSACTIONS: MY PENDING TRANSACTIONS, MY PURCHASES AND SALES, HISTORIC RAPX TRANSACTIONS. FIG. 16 shows the screen which appears in response to a selection of HISTORIC RAPX TRANSACTION S.

HISTORIC RAPX TRANSACTIONS is a listing of all historic RAPX transactions. It may be sorted according to one or more parameters, such as RAPCODE and delivery location, which may be entered using a drop down menu 550.

The listing appears as a scrollable array 552, which includes a line for each transaction. For each transaction, the following information is provided: Date, Shape, Size Range, Color, Clarity, Cut, Polish, Symmetry, Fluorescence, Certification Laboratory, RAPCODE, RAPSPEC, Delivery Location, Price/carat, Price as a Percentage of the Price set forth in the Rapaport Diamond Report Pricelist.

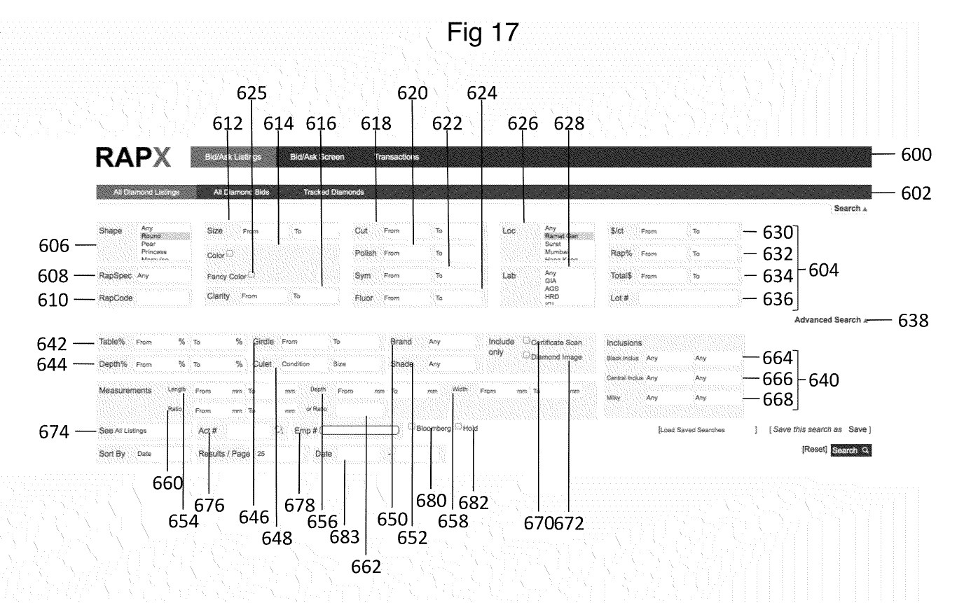

Reference is now made to FIG. 17, which illustrates an initial screen shown to a RapX system administrator. The initial screen includes a top menu bar 600 which includes a top-level menu including at least the following menu items: BID/ASK LISTINGS, BID/ASK SCREEN, TRANSACTIONS. Preferably, the default initial screen indicates a selection of BID/ASK LISTINGS.

Preferably below top menu bar 600 is a secondary menu bar 602, which includes a second-level menu for each of the selectable top level menu items. In this case, the secondary menu bar 602 shows the following second-level menu items for the top menu item BID/ASK LISTINGS: ALL DIAMOND LISTINGS, ALL DIAMOND BIDS, TRACKED DIAMONDS. Preferably, the default initial screen indicates a selection of ALL DIAMOND LISTINGS.

Preferably below secondary menu bar 602 is a searchable array 604 which appears if the top level menu item BID/ASK LISTINGS is selected but irrespective of which of the second-level menu items is selected. The searchable array 604 enables the administrator to search the system, as per the second-level menu item in secondary menu bar 602 that is selected.

The searchable array 604 includes a sub-array 606 enabling searching by diamond shape, a sub-array 608 enabling searching by RapSpec and a sub-array 610 enabling searching by RapCode. RapSpec and RapCode are parameters which are known in the art and defined at www.diamonds.net and are implemented in the prior art Rapaport Diamond Trading Network, commonly known as RapNet. The searchable array 604 also includes subarrays 612, 614 and 616, which enable searching by size, color and clarity respectively and subarrays 618, 620, 622 and 624, which enable searching by cut, polish, symmetry and fluorescence, respectively. The searchable array 604 also preferably includes a Fancy Color check box 625

The searchable array 604 also includes subarrays 626 and 628, which enable searching by delivery location and certification laboratory. The searchable array 604 also includes subarrays 630, 632, 634 and 636, which enable searching by price/carat, % percentage price difference, such as difference from the price set forth in Rapaport Diamond Report pricelist such as the price set forth in Rapaport Diamond Report pricelist, total price and lot #, respectively.

Below searchable array 604 is an icon 638 allowing an administrator to access an advance search functionality. Clicking on icon 638 causes an advanced search array 640 to appear below searchable array 604. The advanced search array 640 preferably includes subarrays 642, 644, 646, 648, 650 and 652, which enable searching by Table %, Depth %, Girdle, Culet, Brand and Shade respectively. The advanced search array 640 preferably also includes subarrays 654, 656, 658, 660 and 662, which enable searching by length, depth, width, and ratio respectively. The advanced search array 640 preferably also includes subarrays 664, 666 and 668, which enable searching by numbers of black, central and milky inclusions.

The advanced search array 640 also includes subarrays 670 and 672, which enable displaying only diamonds which are accompanied by scans of a grading report issued by a certification laboratory and/or a visual image of the diamond. A SEE menu 674 allows the administrator to filter a list of diamonds according to whether the diamonds have or do not have bids placed on them. The advanced search array 640 also includes subarrays 676 and 678, which respectively enable searching by Customer Account Number and by the Employee Number of an employee responsible for the transaction. Checkboxes 680 and 682 allow displaying only diamonds which are on Bloomberg and diamonds which are On Hold, respectively. A date panel 683 enables the administrator to filter diamond listings by a range of dates. Typically, below advanced search array 640 there appears a default list (not shown) of all diamonds in the system. This list can be filtered by the administrator using searchable array 604 and advanced search array 640.

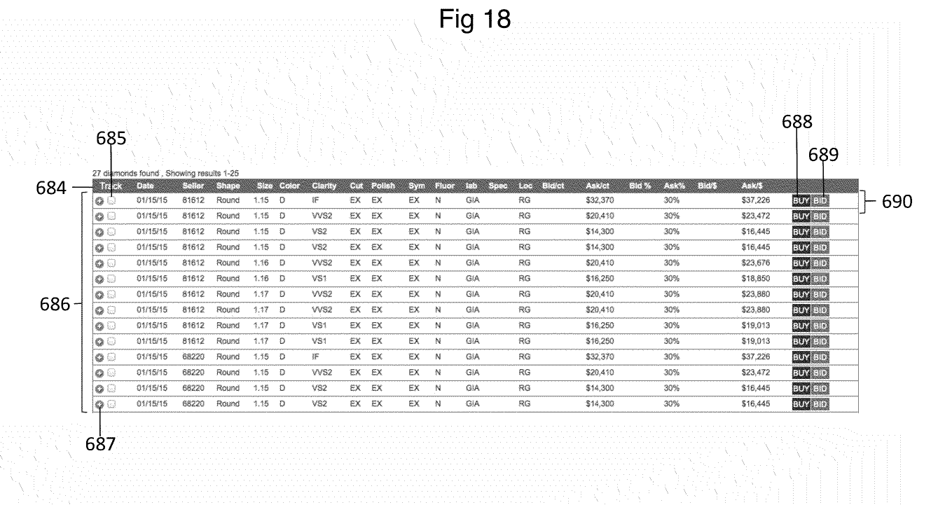

Reference is now made to FIG. 18, which illustrates a search results screen produced by the system as the result of searching using either of searchable arrays 604 and 640. A top line 684 of the search results screen of FIG. 18 includes a Track check box 685 which enables the administrator to track all of the diamonds appearing on the search results screen and also lists various parameters which appear in the listings therebelow. Preferably these parameters include Listing Date, Seller, Shape, Size, Color, Clarity, Cut, Polish, Symmetry, Fluorescence, Certification Laboratory, Rap Spec, Delivery Location, Bid/Ct amount, Ask/Ct amount, Bid % of the price, such as the price set forth in Rapaport Diamond Report pricelist, Ask % of the price, such as the price set forth in Rapaport Diamond Report pricelist, Total Bid price per diamond, and Total Ask price per diamond.

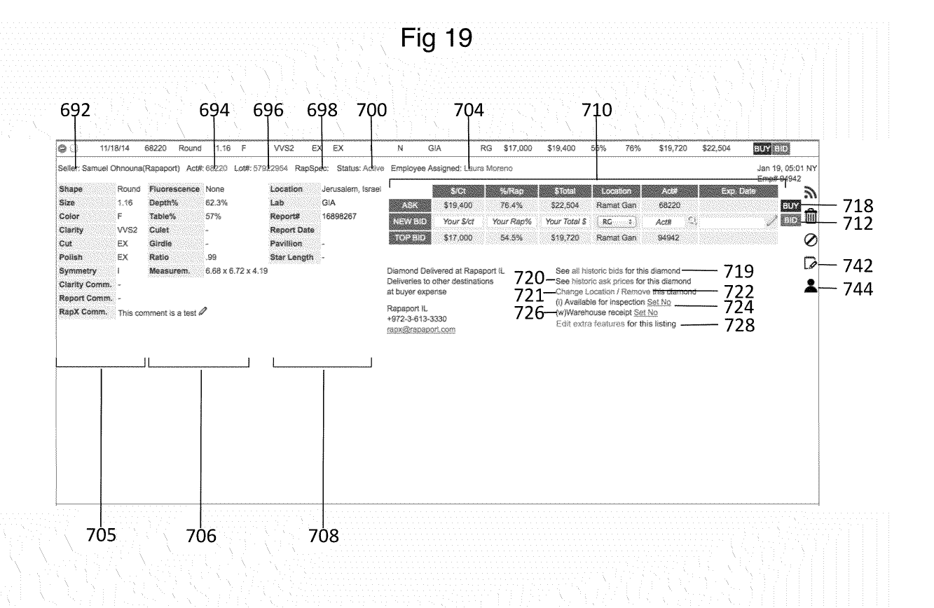

Below the top line 684 is a sequential list 686 of diamonds, one line per diamond, in which all relevant ones of the above parameters appears. Additionally, typically at the left side of each line there appears a clickable+icon 687. Typically at the right side of each line there appears a clickable BUY icon 688 and a clickable BID icon 689. Preferably, when an administrator clicks on any of icons 687, 688 and 689 on a given line, here designated as a line 690, representing a given diamond, a further screen appears. The further screen, shown in FIG. 19, preferably includes a display of the current time and date at a given location, such as New York, and of the administrator's account number.

Turning to FIG. 19, it is seen that a line resembling the selected line 690 from the sequential list 686 of diamonds appears at the top of the screen. The seller's name and company appear at a location 692, the account number of the seller appears at a location 694, the lot number appears at a location 696, the Rap Spec appears at a location 698, the status of the diamond appears at a location 700 and an employee assigned to that diamond at a location 704.

A table 705 preferably includes information as to shape, size, color, clarity, cut, polish and symmetry and also may include comments inserted by sellers as to clarity or other parameters as well as comments inserted by operators of the system. An additional table 706 includes information as to fluorescence, depth %, table %, culet, girdle, ratio and measurements. A further table 708 includes information as to delivery location, certification laboratory, certification report number and date, pavillion and star length. A transaction subscreen 710 indicates price/ct., % of the price, such as the price set forth in Rapaport Diamond Report pricelist, total diamond price, delivery location corresponding to an offered diamond and Account Number of the seller, designated by ASK. Transaction subscreen 710 also indicates a new bid, which can be entered at a NEW BID location and by then clicking on a BID icon 712.

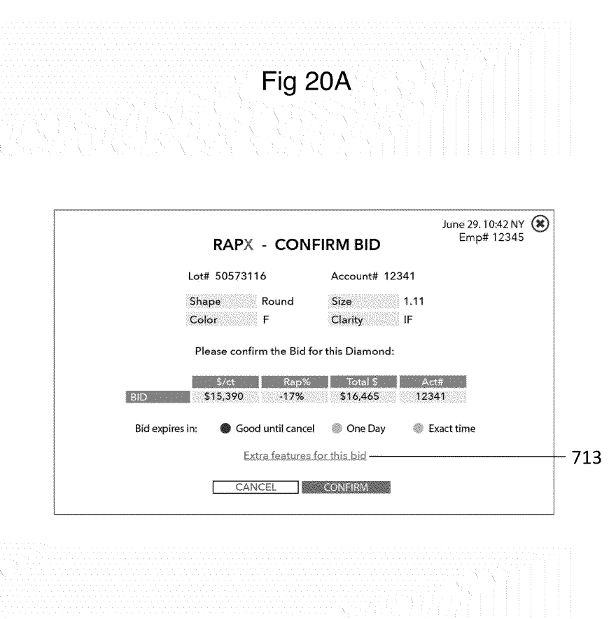

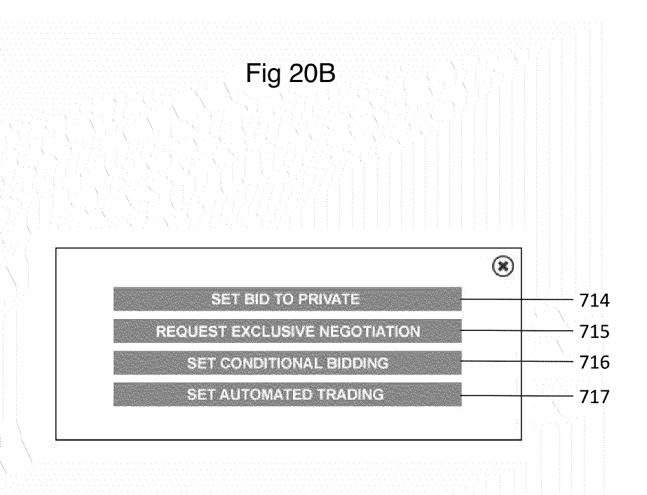

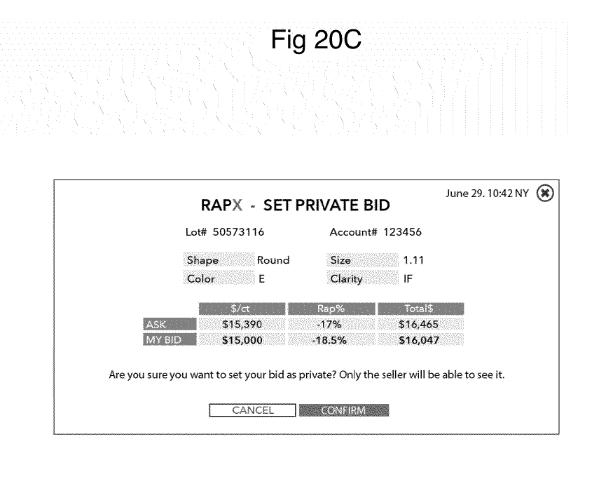

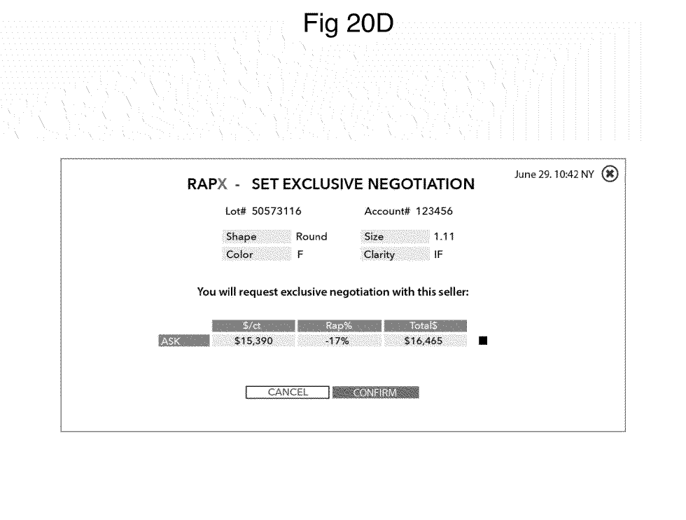

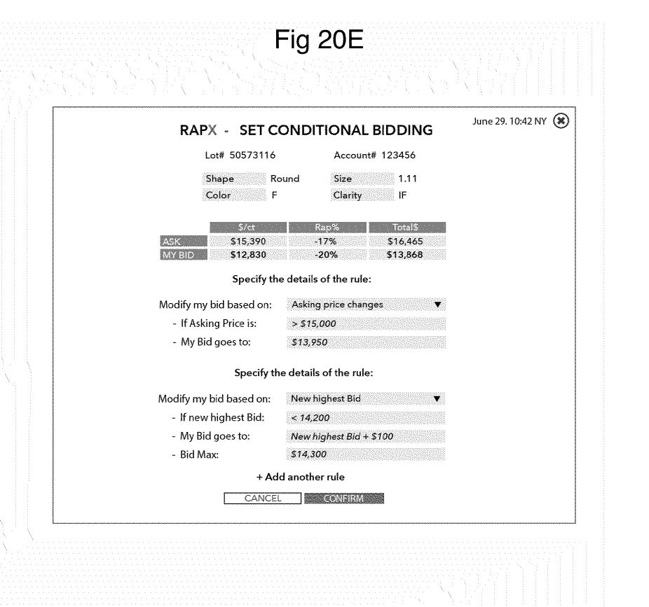

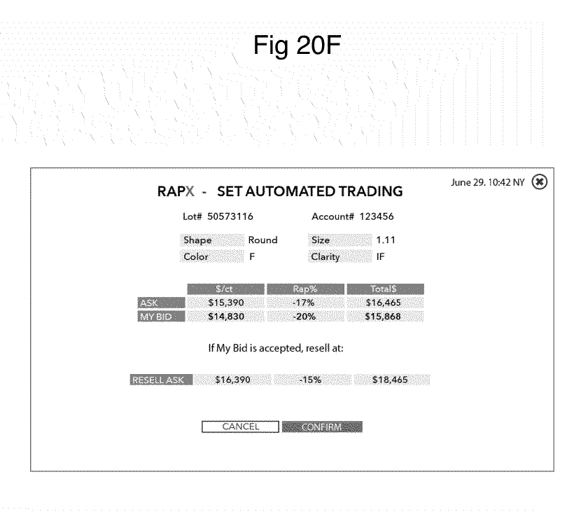

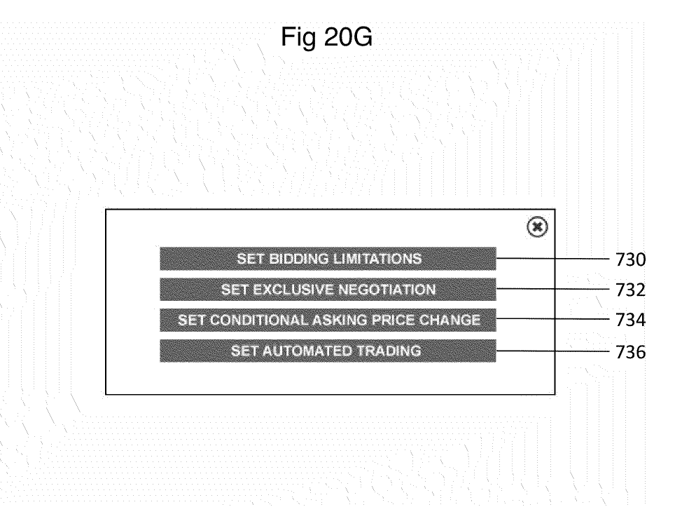

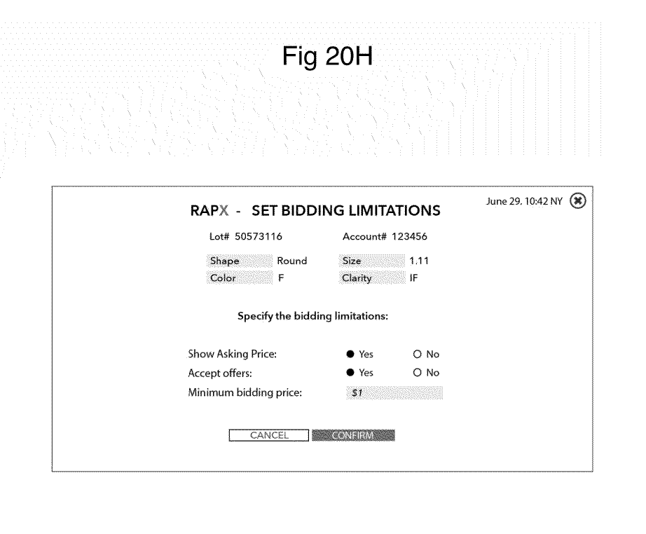

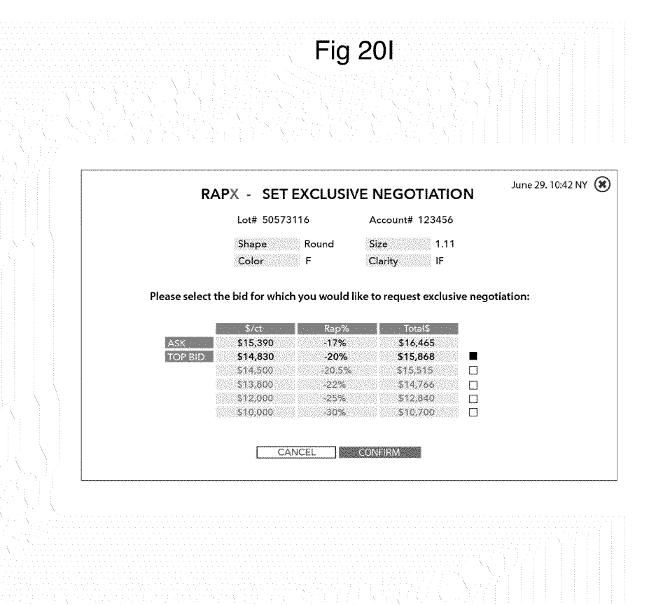

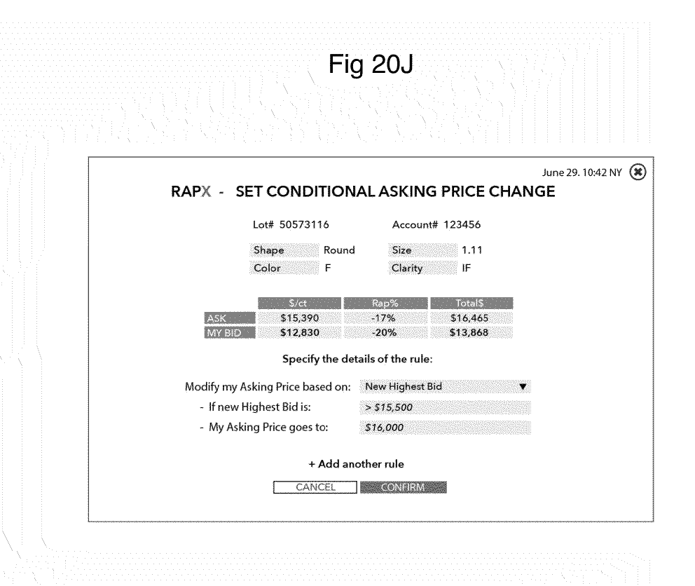

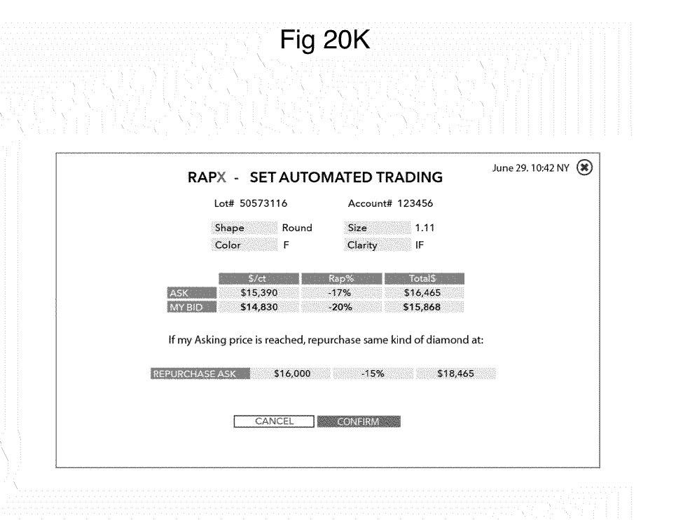

When an administrator clicks on BID icon 712, a bid confirmation screen as shown in FIG. 20A is displayed. As seen in FIG. 20A, the bid confirmation screen typically shows a display including a summary of the diamonds' gemological information, transaction information and a hyperlink 713, which allows the administrator to edit extra features for the bid. When an administrator clicks on hyperlink 713, an Extra features screen as shown in FIG. 20B is displayed. The Extra features screen typically shows a display including a number of extra features that can be edited for the bid, including hyperlinks 714, 715, 716 and 717.

When an administrator clicks on hyperlink 714, a Set Bid to Private screen as shown in FIG. 20C is displayed. As seen in FIG. 20C, the Set Bid to Private screen typically shows a display including a summary of the diamonds' gemological information, and the option for the user to set the bid to private. When an administrator clicks on hyperlink 715, a Set Exclusive Negotiation screen as shown in FIG. 20D is displayed. As seen in FIG. 20D, the screen typically shows a display including a summary of the diamonds' gemological information, and the option for the administrator to set exclusive negotiation with the seller. When an administrator clicks on hyperlink 716, a Set Conditional Bidding screen as shown in FIG. 20E is displayed. As seen in FIG. 20E, the Set Conditional Bidding screen typically shows a display including a summary of the diamonds' gemological information, and the option for the administrator to set conditional bidding based on different events. When an administrator clicks on hyperlink 717, a Set Automated Trading screen as shown in FIG. 20F is displayed. As seen in FIG. 20F, the Set Automated Trading screen typically shows a display including a summary of the diamonds' gemological information, and the option for the user to set automated trading.

Referring again to FIG. 19, an administrator can purchase the diamond for a user as per the offered price and delivery parameters by clicking on a BUY icon 718 and can make a bid for a user, as per the data entered by the administrator at the NEW BID location before clicking on the BID icon 712. It is appreciated that identities of the buying user and selling user in this case are preferably not known to each other.

It is further appreciated that an administrator can indicate the user's bid as either an amount per carat, an amount per diamond or a percentage of the price, such as the price set forth in Rapaport Diamond Report pricelist. The system automatically translates the bid into all of the other formats. The administrator will also indicate the user's account number for the bid or the purchase. If a previous bid has been made by another user for the selected diamond, the particulars of that bid are displayed alongside a TOP BID location.

The screen of FIG. 19 also includes hyperlinks 719, 720, 721, 722, 724 and 726 enabling the administrator to see all the historic bids for a given diamond, see all the historic ask prices for a given diamond, change the delivery location, remove the diamond, modify the availability for inspection and modify whether the diamond has a warehouse receipt or not respectively. An additional Edit Extra features hyperlink 728 is also preferably included.

When an administrator clicks on hyperlink 728, an Extra features screen, as shown in FIG. 20G, is displayed. As seen in FIG. 20G, the Extra features screen typically shows a display including a number of extra features that can be edited for the listing, including hyperlinks 730, 732, 734 and 736. When an administrator clicks on hyperlink 730, a Set Bid Limitations screen, as shown in FIG. 20H, is displayed. As seen in FIG. 20H, the Set Bid Limitations screen typically shows a display including a summary of the diamonds' gemological information, and the option for the administrator to set bidding limitations.

When an administrator clicks on hyperlink 732, a Set Exclusive Negotiation screen, as shown in FIG. 20I is displayed. As seen in FIG. 20I, the Set Exclusive Negotiation screen typically shows a display including a summary of the diamonds' gemological information, and the option for the administrator to set exclusive negotiation with the buyer. When an administrator clicks on hyperlink 734, a Set Conditional Asking Price Change screen, as shown in FIG. 20J, is displayed. As seen in FIG. 20J, the Set Conditional Asking Price Change screen typically shows a display including a summary of the diamonds' gemological information, and the option for the administrator to set conditional Asking Price Change based on different events. When an administrator clicks on hyperlink 736, the Set Automated Trading screen, as shown in FIG. 20K, is displayed. As seen in FIG. 20K, the Set Automated Trading screen typically shows a display including a summary of the diamonds' gemological information, and the option for the administrator to set automated trading.

Referring again to FIG. 19, it is seen that two further icons 742 and 744 enable the administrator to edit the diamond or to assign a specific administrator to a given diamond, respectively.

Turning back to FIG. 17 and specifically to secondary menu bar 602, it is noted that although the foregoing description is directed to an example where ALL DIAMOND LISTINGS has been selected, it is applicable also to a situation wherein any of ALL DIAMOND LISTINGS, ALL DIAMOND BIDS, TRACKED DIAMONDS is selected. Differences in the screens which appear in cases where a different second-level menu item is selected reflect various database filterings.

Specifically for ALL DIAMOND BIDS only diamonds having bids appear, and for TRACKED DIAMONDS, only diamonds tracked by the administrator appear.

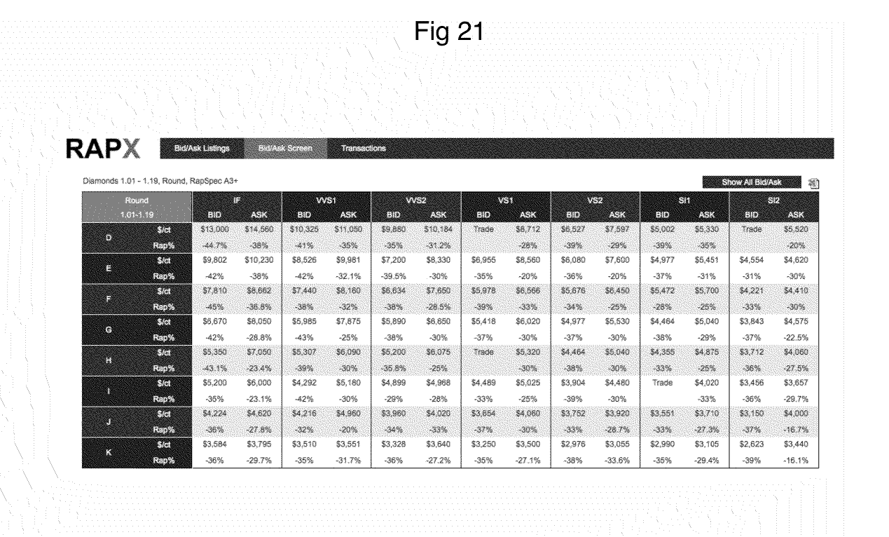

The following description relates to operation of the system when the BID/ASK SCREEN menu item in top menu bar 600 is selected. A typical BID/ASK SCREEN appears in FIG. 21 and preferably displays information for categories of diamonds within a predetermined range of diamond weights, shapes, color scale and clarity scale. In this example, only categories of round diamonds within a weight range of 1.01-1.19 carats appear and these categories are arranged according to the color scale and clarity scale. Preferably, all of the diamond categories appearing in the screen of FIG. 21 have the same RAPSPEC. For each diamond category, there appear both bid and ask prices in US$ and as a percentage of the Rapaport Diamond Report pricelist.

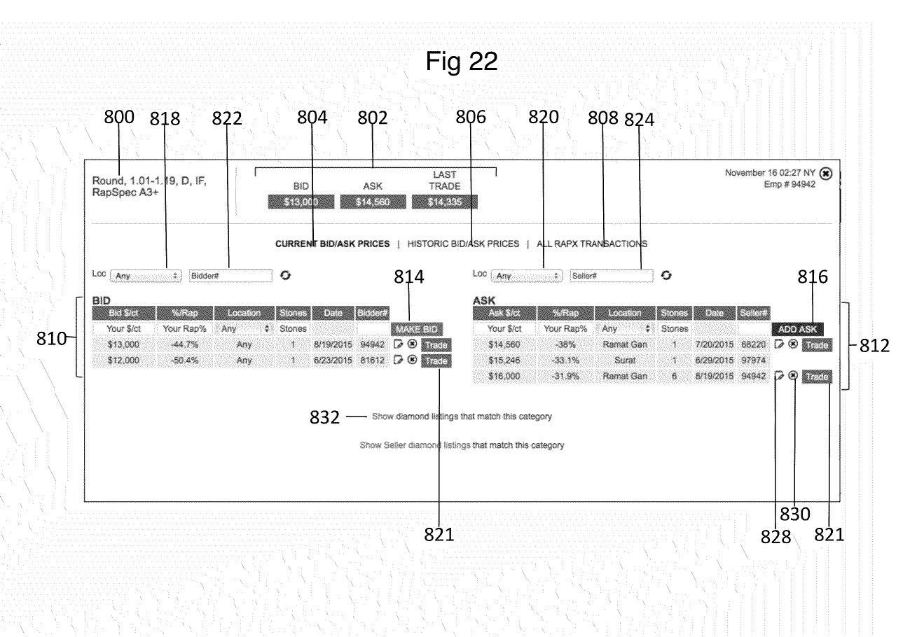

Each of the categories in the screen of FIG. 21 is a hyperlink and when clicked on displays a screen of the type shown in FIG. 22. As seen in FIG. 22 the screen includes a location 800 which describes the category, preferably specifying the diamond weight, shapes color scale and clarity scale of the category and its RAPSPEC. There is also provided at a location 802 an indication of the highest bid price, the lowest asking price and the price of the last transaction for this category in the system, which are designated respectively as BID, ASK and LAST.

There are preferably provided three hyperlinks, 804, 806 and 808 enabling the administrator to display current bid/ask prices, historic bid/ask prices and all RAPX transactions for the selected category. In the illustrated example, which represents a default selection, current bid/ask prices are displayed at locations 810 and 812 respectively.

The table at location 810 preferably lists all of the bids in the system for the selected category of diamonds, arranged from the highest bid to the lowest bid. The number of diamonds under bid is also indicated. The table at location 812 preferably lists all the asking prices in the system for the selected category of diamonds, arranged from the lowest asking price to the highest asking price. The number of diamonds offered for sale for the given asking price is also indicated.

Referring to location 810, it is appreciated that an administrator may add a bid by clicking on a MAKE BID icon 814. Referring to location 812, it is appreciated that an administrator may add an asking price by clicking on an ADD ASK icon 816. An administrator may sell one or more diamonds in response to a specific bid indicated at location 810 for a delivery location indicated via a DELIVERY LOCATION menu 818. Similarly, an administrator may buy one or more diamonds in response to a specific ask indicated at location 812 for a delivery location indicated via a DELIVERY LOCATION menu 820 by simply clicking on a TRADE icon 821. The administrator may also filter the results displayed at location 810, by Bidder Account Number, and at location 812, by Seller Account Number, using search panels 822 and 824 respectively.

In addition, the administrator may view icons 828 (Edit) and 830 (Delete) next to the TRADE icon. A My Activity Only checkbox, such as checkbox 328 of FIG. 8, may be included which checkbox is unchecked in a default state and allows the administrator to display only the bids and asking prices placed by that administrator. A SHOW DIAMOND LISTINGS THAT MATCH THIS CATEGORY hyperlink 832, when clicked, displays a list, similar to that shown in FIG. 18, of the diamonds in the system which fall within the category appearing at location 800 and meeting the delivery location criteria entered in menu 820.

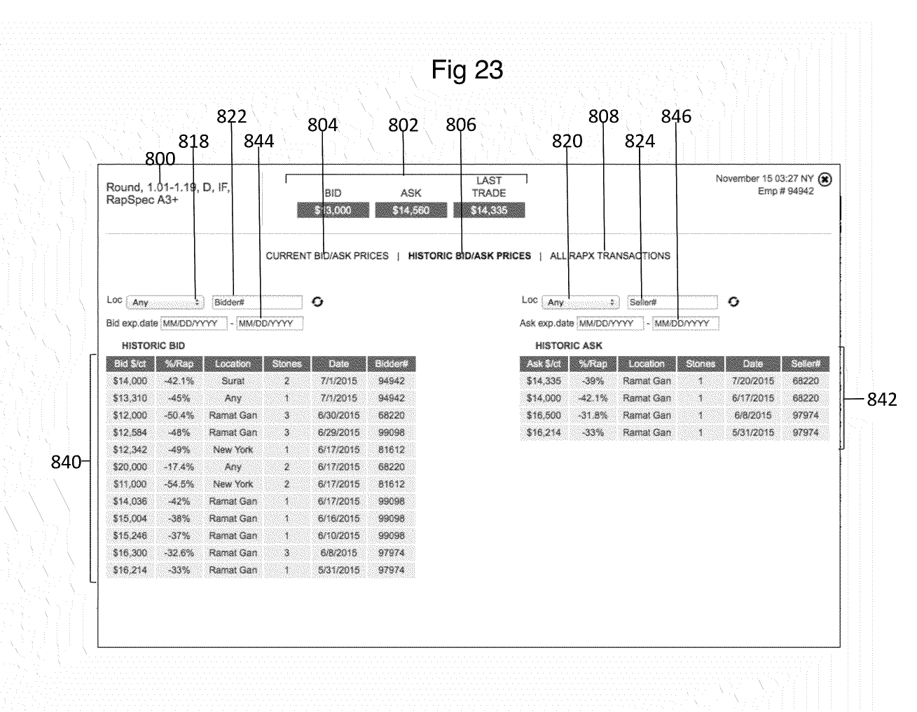

If the administrator clicks on the HISTORIC BID/ASK PRICES hyperlink 806 in FIG. 22, a screen of the type shown in FIG. 23 appears. As seen in FIG. 23, the screen includes location 800, which describes the category, preferably specifying the diamond weight, shape, color scale and clarity scale of the category and its RAPSPEC. There is also provided at location 802, an indication of the highest bid price, the lowest asking price and the price of the last transaction for this category in the system, which are designated respectively as BID, ASK and LAST TRADE.

There are preferably provided three hyperlinks, 804, 806 and 808, enabling the administrator to display current bid/ask prices, historic bid/ask prices and all RAPX transactions for the selected category. In the illustrated example historic bid/ask prices are displayed at locations 840 and 842 respectively.

The table at location 840 preferably lists all of the historic bids in the system, including only canceled and expired bids, for the selected category of diamonds, arranged from the highest bid to the lowest bid. The number of diamonds per lot referenced in a canceled or expired bid is also indicated. The table at location 842 preferably lists all of the historic asking prices in the system for the selected category of diamonds, arranged from the lowest asking price to the highest asking price. The number of diamonds per lot referenced in an offer for sale is also indicated.

DELIVERY LOCATION menu 818 allows the administrator to select a specific historic delivery location for the historic bid appearing at location 840, while DELIVERY LOCATION menu 820 allows the administrator to select a specific historic delivery location for the historic Asking Prices appearing in location 842. Two date panels 844 and 846 enable the administrator to enter a range of dates which can be used to filter the results appearing at locations 840 and 842 respectively. The administrator may also filter the results displayed at location 840 by Bidder Account Number by using search panel 822, as well as the results displayed on location 842 by Seller Account Number by using search panel 824.

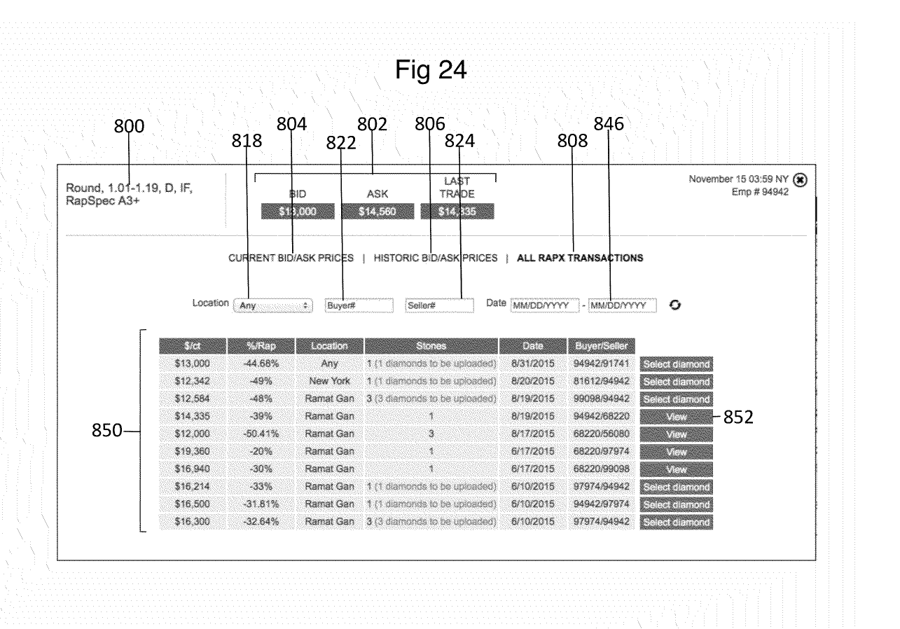

If the administrator clicks on the ALL RAPX TRANSACTIONS hyperlink 808 in FIG. 22 or 23, a screen of the type shown in FIG. 24 appears. As seen in FIG. 24, the screen includes location 800 which describes the category, preferably specifying the diamond weight, shapes color scale and clarity scale of the category and its RAPSPEC. There is also provided at location 802 an indication of the highest bid price, the lowest asking price and the price of the last transaction for this category in the system, which are designated respectively as BID, ASK and LAST TRADE. There are preferably provided three hyperlinks, 804, 806 and 808 enabling the administrator to display current bid/ask prices, historic bid/ask prices and all RAPX transactions for the selected category. In the illustrated example, All RapX Transactions are displayed at a location 850.

A RapX Transaction is deemed to exist once the system matches a willing buyer and a willing seller for one or more diamonds offered for sale or purchase such that a deal may be made between the buyer and seller. Such a transaction is preferably implemented by computerized deal implementing functionality operative following the making of the deal, for transferring payment relating to the deal as per the buyer's bid and seller's asking price, from the buyer to the seller via an account administered by the computerized deal implementing functionality and for transferring the one or more diamonds which are the subject of the deal from the seller to the buyer via a physical facility controlled by the computerized deal implementing functionality. The transaction is deemed to be cleared, once the one or more diamonds have been delivered and the payment has been received.

The table at location 850 preferably lists all the RAPX transactions carried out through the Bid/Ask Screen for the selected category of diamonds, arranged by date. The number of diamonds per transaction is also indicated.

An icon 852 appears alongside the listing of that transaction. Clicking on icon 852 causes details of the transaction to be displayed. DELIVERY LOCATION menu 818 allows the administrator to select transactions having a specific delivery location among all of the transactions appearing at location 850. Date panel 846 enables the administrator to enter a range of dates which can be used to filter the results appearing at location 850. The administrator may also filter the results displayed at location 850 by buyer Account Number, using search panel 822, and by seller Account Number, using search panel 824.

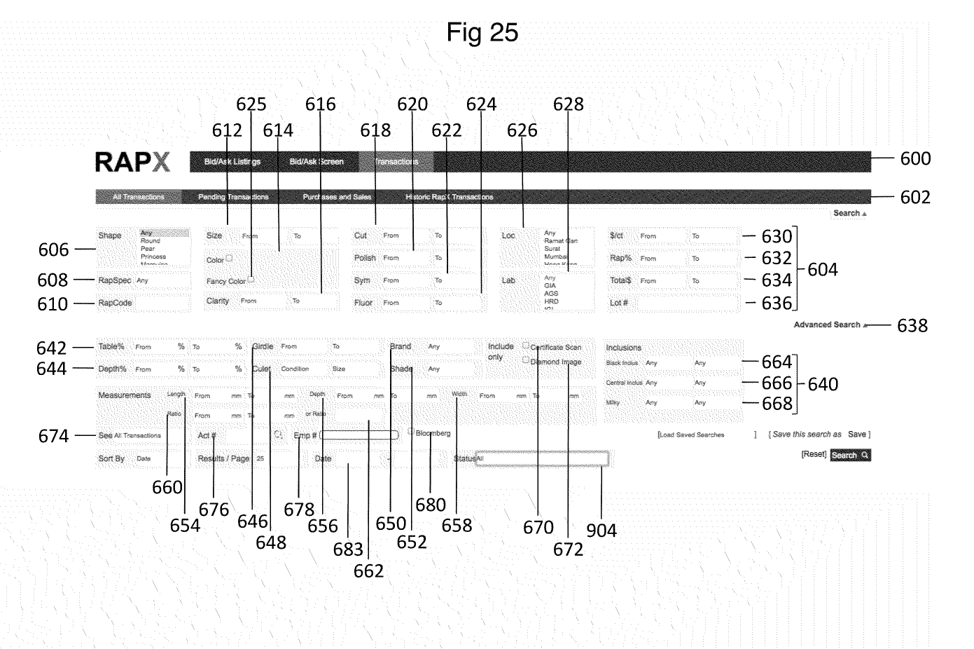

Reference is now made to FIG. 25, which relates to operation of the system when the TRANSACTIONS menu item in top menu bar 600 is selected.

Preferably below top menu bar 600 is secondary menu bar 602. In this case, the secondary menu bar 602 shows the following second-level menu items for the top menu item TRANSACTIONS: ALL TRANSACTIONS, PENDING TRANSACTIONS, PURCHASES AND SALES, HISTORIC RAPX TRANSACTIONS. Preferably, the default initial screen when selecting TRANSACTIONS indicates a selection of ALL TRANSACTIONS. ALL TRANSACTIONS lists all the current open transactions and finalized transactions, which have already been cleared, carried out in the past through the system.

Preferably below secondary menu bar 602 is searchable array 604, which allows a user to filter the list of diamonds in a pending or cleared transaction.

The searchable array 604 preferably includes sub-array 606, enabling searching by diamond shape, sub-array 608, enabling searching by RapSpec, and sub-array 610, enabling searching by RapCode. RapSpec and RapCode are parameters which are known in the art and are implemented in the prior art Rapaport Diamond Trading Network, commonly known as RapNet. The searchable array 604 also preferably includes subarrays 612, 614 and 616, which enable searching by size, color and clarity respectively and subarrays 618, 620, 622 and 624, which enable searching by cut, polish, symmetry and fluorescence, respectively. The searchable array 604 also preferably includes Fancy Color checkbox 625.

The searchable array 604 also preferably includes subarrays 626 and 628, which enable searching by delivery location and certification laboratory. The searchable array 604 also includes subarrays 630, 632, 634 and 636, which enable searching by price/carat, % percentage price difference, such as difference from the price set forth in Rapaport Diamond Report pricelist, total price and lot 4, respectively.

Below searchable array 604 is icon 638 allowing a user to access an advance search functionality. Clicking on icon 638 causes advanced search array 640 to appear below searchable array 604. The advanced search array 640 preferably includes subarrays 642, 644, 646, 648, 650 and 652, which enable searching by Table %, Depth %, Girdle, Culet, Brand and Shade respectively. The advanced search array 640 preferably also includes subarrays 654, 656, 658, 660 and 662, which enable searching by length, depth, width, and ratio respectively. The advanced search array 640 preferably also includes subarrays 664, 666 and 668, which enable searching by numbers of black, central and milky inclusions.

The advanced search array 640 also includes subarrays 670 and 672, which enable displaying only diamonds with Certificate Scan and Diamond Image respectively. SEE menu 674 allows an administrator to filter the list of diamonds according to whether the transaction is in process or finalized. Furthermore, the administrator is able to filter by status of the transaction process by a subarray 904. The advanced search array 640 also includes subarrays 676 and 678, which enable searching by Account Number and Employee Number respectively. Checkbox 680 allows the administrator to display only diamonds on Bloomberg. Date panel 683 enables entering and filtering by a range of dates. Typically, below advanced search array 640 there appears a default list (not shown) of all the open and finalized transactions in the system. This list can be filtered by the administrator using searchable array 604 and advanced search array 640.

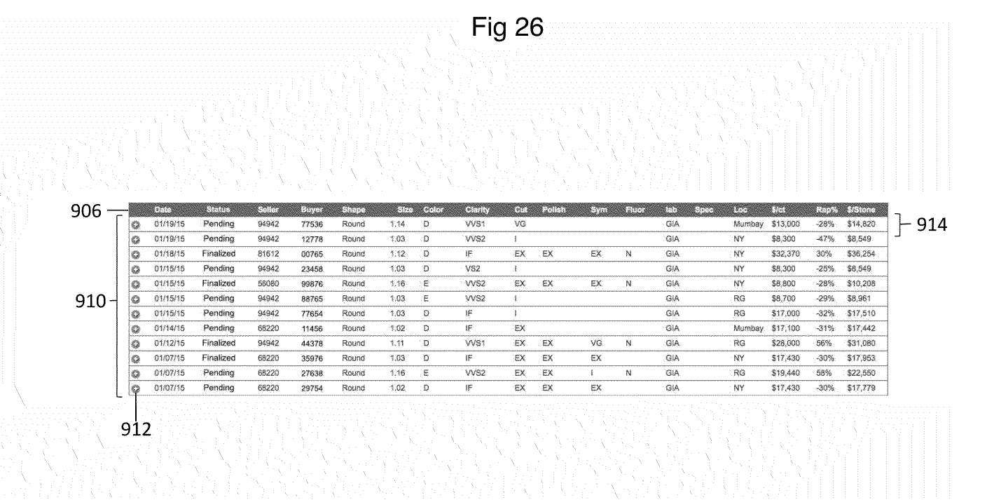

Reference is now made to FIG. 26, which illustrates a search results screen produced by the system as the result of searching using either of searchable arrays 604 and 640. A top line 906 of the search results screen of FIG. 26 lists various parameters which appear in the listings therebelow. Preferably these parameters include Date, Status, Seller, Buyer, Shape, Size, Color, Clarity, Cut, Polish, Symmetry, Fluorescence, Certification Laboratory, Rap Spec, Delivery Location, $/Ct amount, % of the price, such as the price set forth in Rapaport Diamond Report pricelist and total price per diamond.

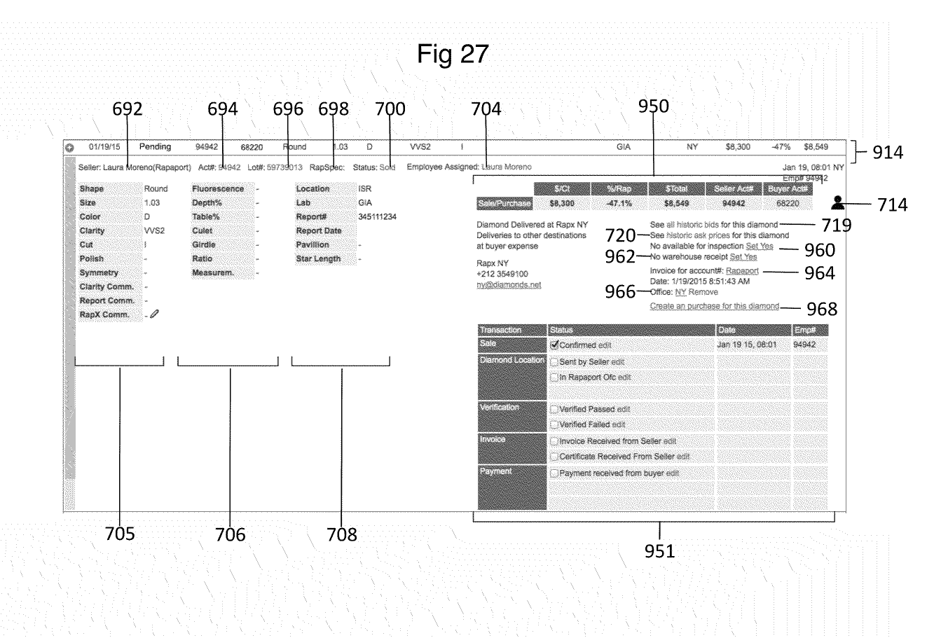

Below the top line 906 is a sequential list 910 of diamonds under transaction or transacted in the past, one line per diamond, in which all relevant ones of the above parameters appear. Additionally, typically at the left side of each line there appears a clickable+icon 912. By clicking on the +icon 912 for a given line 914 in list 910, FIG. 27 will appear.

Turning now to FIG. 27, it is seen that a line resembling the selected line 914 from the sequential list 910 of diamonds appears at the top of the screen. The seller's name and company appear at location 692, the account number of the seller appears at location 694, the lot number appears at location 696, the Rap Spec appears at location 698, the status of the diamond appears at location 700 and the Employee Assigned at location 704.

Table 705 preferably includes information as to shape, size, color, clarity, cut, polish and symmetry and also may include comments inserted by sellers as to clarity or other parameters as well as comments inserted by operators of the system. Additional table 706 includes information as to fluorescence, depth %, table %, culet, girdle, ratio and measurements. Further table 708 includes information as to delivery location, certification laboratory, certification report number and date, pavillion and star length. An additional table 950 includes the following transaction parameters for a given line 914 in list 910 appearing in FIG. 26: Price per carat, price as a percentage of the Rapaport Diamond Report pricelist and total price per diamond.

FIG. 27 also includes hyperlinks 719, 720, 960, 962, 964, 966 and 968, enabling the administrator to see all the historic bids for a given diamond, see all the historic ask prices for a given diamond, modify availability of given information for inspection by given users, indicate whether the diamond has a warehouse receipt or not, display an invoice, change a delivery location and create a purchase order respectively.

Following the making of a deal between a buyer and seller, according to any one of the scenarios described hereinabove, payment relating to the deal is preferably transferred from the buyer to the seller via an account administered by computerized deal implementing functionality. The one or more diamonds which are the subject of the deal are preferably transferred from the seller to the buyer via a physical facility, such as a warehouse, controlled by the computerized deal implementing functionality. Deal guaranteeing functionality may provide a guarantee of transfer of the payment and delivery of the item to the seller and buyer, respectively. Additionally, item quality certification functionality may provide certification of at least one quality parameter of the diamonds which are the subject of the deal.

A further table 951 shown in FIG. 27 summarizes the different steps in the transaction process, as preferably implemented by the computerized deal implementing functionality, deal guaranteeing functionality and quality certification functionality of the present invention. Each step is displayed in a different row and has a checkbox next to it. The steps as set out in table 951 preferably include ‘Sale’, relating to status of the sale as confirmed and ‘Diamond Location’, relating to the physical transfer and location of the one or more diamonds which are the subject of the transaction. The status of the diamond location may include that the diamond has been sent by the seller and/or is being held in a physical facility controlled by the computerized deal implementing functionality such as an office or warehouse, prior to transfer to the buyer.

The steps as set out in table 951 further preferably include ‘Verification’ relating to whether quality verification of the one or more diamonds which are the subject of the deal has been passed or failed; ‘Invoice’ relating to receipt of an invoice and/or certificate from the seller involved in the transaction and ‘Payment’, relating to receipt of payment from the buyer via an account administered by the computerized implementing functionality. Once a step is finalized, an administrator may mark it on table 951, registering automatically thereby the following details: date and the employee number of the authorized administrator. The authorized administrator may also enter comments on each step. Once all of the steps are completed (marked in their respective checkboxes) the transaction is considered cleared.

It will be appreciated by persons skilled in the art that the present invention is not limited by what has been particularly shown and described hereinabove. Rather the scope of the present invention includes combinations and subcombinations of features described above as well as modifications and improvements thereof that are not in the prior art.

1. A computer-implemented trading platform comprising:
computerized listing functionality providing to users a listing of asking prices and bid prices for a multiplicity of items;
computerized deal making functionality enabling a buying user to make a deal with a selling user by making a bid which matches an asking price and enabling a selling user to make a deal with a buying user by accepting a bid, wherein identities of said buying user and said selling user are not known to each other; and
computerized deal implementing functionality operative following the making of a deal, for transferring payment relating to said deal as per said bid and said asking price from said buying user to said selling user via an account administered by said computerized deal implementing functionality and transferring said item, which item is the subject of said deal from said selling user to said buying user via a physical facility controlled by said computerized deal implementing functionality.

2. A computer-implemented trading platform according to claim 1 and also comprising deal guaranteeing functionality providing a guarantee of transfer of said payment and delivery of said item to said selling user and said buying user respectively.

3. A computer-implemented trading platform according to claim 1 and also comprising item quality certification functionality, providing a certification of at least one quality parameter of a plurality of said multiplicity of items.

4. A computer-implemented trading platform according to claim 1 and wherein:
said computerized listing functionality provides to users a listing of asking prices and bid prices for a multiplicity of items at given delivery locations;
said computerized deal making functionality enables a buying user to make a deal with a selling user by making a bid which matches an asking price for a delivery location specified by said selling user and enables a selling user to make a deal with a buying user by accepting a bid for a delivery location specified by said buying user, wherein identities of said buying user and said selling user are not known to each other; and
said computerized deal implementing functionality is operative following the making of a deal to transfer payment relating to said deal as per said bid and said asking price from said buying user to said selling user via an account administered by said computerized deal implementing functionality and to transfer said item which is the subject of said deal from said selling user to said buying user at a delivery location agreed by said selling user and said buying user in said deal, via said physical facility controlled by said computerized deal implementing functionality.

5. A computer-implemented trading platform according to claim 1 and wherein said items are selected from precious stones and diamonds.

6. A computer-implemented trading platform according to claim 1 and wherein said computerized listing functionality causes at least one screen to be displayed including at least a menu bar comprising at least the following selectable top level menu items: BID/ASK LISTINGS, BID/ASK SCREEN and TRANSACTIONS.

7. A computer-implemented trading platform according to claim 6 and wherein a default initial screen indicates a selection of BID/ASK LISTINGS.

8. A computer-implemented trading platform according to claim 6 and wherein said at least one screen includes a second-level menu for each of said selectable top level menu items, said second-level menu including at least one of the following second-level menu items for said top level menu item BID/ASK LISTINGS: ALL DIAMOND LISTINGS, MY DIAMONDS FOR SALE, MY DIAMONDS WITH BIDS, MY BIDS, ALL DIAMOND BIDS, TRACKED DIAMONDS, ADD DIAMONDS.

9. A computer-implemented trading platform according to claim 8 and wherein said at least one screen includes a searchable array which appears when said top level menu item BID/ASK LISTINGS is selected and irrespective of which of said second-level menu items is selected, said searchable array including at least one sub-array enabling searching by at least three of diamond shape, size, color, clarity, cut, polish, symmetry and fluorescence.

10. A computer-implemented trading platform according to claim 9 and wherein said searchable array also includes at least one subarray enabling searching by at least one of delivery location and certification laboratory.

11. A computer-implemented trading platform according to claim 9 and wherein said searchable array also includes at least one subarray enabling searching by at least one of price/carat, % percentage price difference between at least one of an asking price and a bid price and a benchmark price, total price and lot number.

12. A computer-implemented trading platform according to claim 9 and wherein said searchable array also includes an advanced search array including at least one subarray, which enables searching by at least one of table %, depth %, girdle, culet, brand and shade.

13. A computer-implemented trading platform according to claim 9 and wherein said searchable array also includes an advanced search array including at least one subarray which enables searching by at least one of length, depth, width, ratio and numbers of at least one of black, central and milky inclusions.

14. A computer-implemented trading platform according to claim 1 and wherein said computerized listing functionality also provides a list of all diamonds listed on said platform, said list being filterable by a user.

15. A computer-implemented trading platform according to claim 1 and wherein said computerized deal making functionality includes functionality enabling said buying user to request exclusivity with respect to a given item.

16. A computer-implemented trading platform according to claim 1 and wherein said computerized deal making functionality includes functionality enabling at least one of said buying user and said selling user to interact via said platform in a manner other than accepting or declining to accept a given bid.

17. A computer-implemented trading platform according to claim 1 and wherein said computerized deal making functionality includes functionality enabling said buying user to request privacy with respect to a given item.

18. A computer-implemented trading platform according to claim 1 and wherein said computerized listing functionality includes functionality enabling display to a user of comments inserted by an operator of said platform regarding a specific item.

19. A computer-implemented trading platform according to claim 1 and wherein said computerized deal making functionality includes functionality enabling said selling user to set bidding limitations with respect to a given item.

20. A computer-implemented trading platform according to claim 19 and wherein said computerized deal making functionality includes functionality enabling said buying user to at least set and change a conditional asking price.

21. A computer-implemented method for trading comprising:
providing to users, using computerized listing functionality, a listing of asking prices and bid prices for a multiplicity of items;
enabling a buying user, utilizing computerized deal making functionality, to make a deal with a selling user by making a bid which matches an asking price;
enabling a selling user, utilizing said computerized deal making functionality, to make a deal with a buying user by accepting a bid, wherein identities of said buying user and said selling user are not known to each other;
transferring payment relating to said deal, utilizing computerized deal implementing functionality, following the making of said deal, as per said bid and said asking price from said buying user to said selling user via an account administered by said computerized deal implementing functionality; and
transferring said item, which is the subject of said deal from said selling user to said buying user via a physical facility controlled by said computerized deal implementing functionality.

22. A computer-implemented method for trading according to claim 21 and also comprising providing a guarantee, utilizing computerized deal guaranteeing functionality, of transfer of said payment and delivery of said item to said selling user and said buying user respectively.

23. A computer-implemented method for trading according to claim 21 and also comprising providing a certification, utilizing item quality certification functionality, of at least one quality parameter of a plurality of said multiplicity of items.

24. A computer-implemented method for trading according to claim 21 and wherein:
said computerized listing functionality provides to users a listing of asking prices and bid prices for a multiplicity of items at given delivery locations;
said computerized deal making functionality enables a buying user to make a deal with a selling user by making a bid which matches an asking price for a delivery location specified by said selling user and enables a selling user to make a deal with a buying user by accepting a bid for a delivery location specified by said buying user, wherein identities of said buying user and said selling user are not known to each other; and
said computerized deal implementing functionality is operative following the making of said deal for transferring payment relating to said deal as per said bid and said asking price from said buying user to said selling user via an account administered by said computerized deal implementing functionality and transferring said item which is the subject of said deal from said selling user to said buying user at said delivery location agreed by said selling user and said buying user in said deal, via said physical facility controlled by said computerized deal implementing functionality.

25. A computer-implemented method for trading according to claim 21 and wherein said items are selected from precious stones and diamonds.

26. A computer-implemented method for trading according to claim 21 and wherein said computerized listing functionality causes at least one screen to be displayed including at least a menu bar comprising at least the following selectable top level menu items: BID/ASK LISTINGS, BID/ASK SCREEN and TRANSACTIONS.

27. A computer-implemented method for trading according to claim 26 and wherein at least a default initial screen indicates a selection of BID/ASK LISTINGS.

28. A computer-implemented method for trading according to claim 26 and wherein said at least one screen includes a second-level menu for each of said selectable top level menu items, said second-level menu including at least one of the following second-level menu items for said top menu item BID/ASK LISTINGS: ALL DIAMOND LISTINGS, MY DIAMONDS FOR SALE, MY DIAMONDS WITH BIDS, MY BIDS, ALL DIAMOND BIDS, TRACKED DIAMONDS, ADD DIAMONDS.

29. A computer-implemented method for trading according to claim 28 and wherein said at least one screen includes a searchable array which appears when said top level menu item BID/ASK LISTINGS is selected and irrespective of which of said second-level menu items is selected, said searchable array including at least one sub-array enabling searching by at least three of diamond shape, size, color, clarity, cut, polish, symmetry and fluorescence.

30. A computer-implemented method for trading according to claim 29 and wherein said searchable array also includes at least one subarray enabling searching by at least one of delivery location and certification laboratory.

31. A computer-implemented method for trading according to claim 29 and wherein said searchable array also includes at least one subarray enabling searching by at least one of price/carat, % percentage price difference between at least one of an asking price and a bid price and a benchmark price, total price and lot number.

32. A computer-implemented method for trading according to claim 29 and wherein said searchable array also includes an advanced search array including at least one subarray, which enables searching by at least one of table %, depth %, girdle, culet, brand and shade.

33. A computer-implemented method for trading according to claim 29 and wherein said searchable array also includes an advanced search array including at least one subarray which enables searching by at least one of length, depth, width, ratio and numbers of at least one of black, central and milky inclusions.

34. A computer-implemented method for trading according to claim 21 and wherein said computerized listing functionality also provides a list of all diamonds listed on a platform, said list being filterable by a user.

35. A computer-implemented method for trading according to claim 21 and wherein said computerized deal making functionality includes functionality enabling said buying user to request exclusivity with respect to a given item.

36. A computer-implemented method for trading according to claim 21 and wherein said computerized deal making functionality includes functionality enabling at least one of said buying user and said selling user to interact in a manner other than accepting or declining to accept a given bid.

37. A computer-implemented method for trading according to claim 21 and wherein said computerized deal making functionality includes functionality enabling said buying user to request privacy with respect to a given item.

38. A computer-implemented method for trading according to claim 21 and wherein said computerized listing functionality includes functionality enabling display to a user of comments inserted by an operator regarding a specific item.

39. A computer-implemented method for trading according to claim 21 and wherein said computerized deal making functionality includes functionality enabling said selling user to set bidding limitations with respect to a given item.

40. A computer-implemented method for trading according to claim 39 and wherein said computerized deal making functionality includes functionality enabling said buying user to at least set and change a conditional asking price.

41. A non-transitory computer readable medium having stored thereupon computer instructions including code segments having the following functionalities:
computerized listing functionality providing to users a listing of asking prices and bid prices for a multiplicity of items;
computerized deal making functionality enabling a buying user to make a deal with a selling user by making a bid which matches an asking price and enabling a selling user to make a deal with a buying user by accepting a bid, wherein identities of said buying user and said selling user are not known to each other; and
computerized deal implementing functionality operative following the making of a deal for transferring payment relating to said deal as per said bid and said asking price from said buying user to said selling user via an account administered by said computerized deal implementing functionality and transferring said item, which is the subject of said deal from said selling user to said buying user via a physical facility controlled by said computerized deal implementing functionality.

42. A non-transitory computer readable medium according to claim 41 and wherein said instructions also include code segments having deal guaranteeing functionality providing a guarantee of transfer of said payment and delivery of said item to said selling user and said buying user respectively.

43. A non-transitory computer readable medium according to claim 41 and wherein said instructions also include code segments having item quality certification functionality, providing a certification of at least one quality parameter of a plurality of said multiplicity of items.

44. A non-transitory computer readable medium according to claim 41 and wherein:
said computerized listing functionality provides to users a listing of asking prices and bid prices for a multiplicity of items at given delivery locations;
said computerized deal making functionality enables a buying user to make a deal with a selling user by making a bid which matches an asking price for a delivery location specified by said selling user and enables a selling user to make a deal with a buying user by accepting a bid for a delivery location specified by said buying user, wherein identities of said buying user and said selling user are not known to each other; and
said computerized deal implementing functionality is operative following the making of said deal for transferring payment relating to said deal as per said bid and said asking price from said buying user to said selling user via an account administered by said computerized deal implementing functionality and transferring said item which is the subject of said deal from said selling user to said buying user at a delivery location agreed by said selling user and said buying user in said deal, via said physical facility controlled by said computerized deal implementing functionality.

45. A non-transitory computer readable medium according to claim 41, wherein said items are selected from precious stones and diamonds.

46. A non-transitory computer readable medium according to claim 41 and wherein said computerized listing functionality causes at least one screen to be displayed including at least a menu bar comprising at least the following selectable top level menu items: BID/ASK LISTINGS, BID/ASK SCREEN and TRANSACTIONS.

47. A non-transitory computer readable medium according to claim 46 and wherein at least a default initial screen indicates a selection of BID/ASK LISTINGS.

48. A non-transitory computer readable medium according to claim 46 and wherein said at least one screen includes a second-level menu for each of said selectable top level menu items, said second-level menu including at least one of the following second-level menu items for said top menu item BID/ASK LISTINGS: ALL DIAMOND LISTINGS, MY DIAMONDS FOR SALE, MY DIAMONDS WITH BIDS, MY BIDS, ALL DIAMOND BIDS, TRACKED DIAMONDS, ADD DIAMONDS.

49. A non-transitory computer readable medium according to claim 48 and wherein said at least one screen includes a searchable array which appears when said top level menu item BID/ASK LISTINGS is selected and irrespective of which of said second-level menu items is selected, said searchable array including at least one sub-array enabling searching by at least three of diamond shape, size, color, clarity, cut, polish, symmetry and fluorescence.

50. A non-transitory computer readable medium according to claim 49 and wherein said searchable array also includes at least one subarray enabling searching by at least one of delivery location and certification laboratory.

51. A non-transitory computer readable medium according to claim 49 and wherein said searchable array also includes at least one subarray enabling searching by at least one of price/carat, % percentage price difference between at least one of an asking price and a bid price and a benchmark price, total price and lot number.

52. A non-transitory computer readable medium according to claim 49 and wherein said searchable array also includes an advanced search array including at least one subarray, which enables searching by at least one of table %, depth %, girdle, culet, brand and shade.

53. A non-transitory computer readable medium according to claim 49 and wherein said searchable array also includes an advanced search array including at least one subarray which enables searching by at least one of length, depth, width, ratio and numbers of at least one of black, central and milky inclusions.

54. A non-transitory computer readable medium according to claim 49, and wherein said computerized listing functionality also provides a list of all diamonds listed on a platform, said list being filterable by a user.

55. A non-transitory computer readable medium according to claim 41 and wherein said computerized deal making functionality includes functionality enabling said buying user to request exclusivity with respect to a given item.

56. A non-transitory computer readable medium according to claim 41 and wherein said computerized deal making functionality includes functionality enabling at least one of said buying user and said selling user to interact in a manner other than accepting or declining to accept a given bid.

57. A non-transitory computer readable medium according to claim 41 and wherein said computerized deal making functionality includes functionality enabling said buying user to request privacy with respect to a given item.

58. A non-transitory computer readable medium according to claim 41 and wherein said computerized listing functionality includes functionality enabling display to a user of comments inserted by an operator regarding a specific item.

59. A non-transitory computer readable medium according to claim 41 and wherein said computerized deal making functionality includes functionality enabling said selling user to set bidding limitations with respect to a given item.

60. A non-transitory computer readable medium according to claim 59 and wherein said computerized deal making functionality includes functionality enabling said buying user to at least set and change a conditional asking price.
